(19) United States
(12) Patent Application Publication
(10) Pub. No.: US 2021/0345630 A1
(43) Pub. Date: Nov. 11, 2021

(54) Use of Sodium Bisulfate in Shelf Stable Ready-to-Eat Combinations of Fruit, Vegetable, and/or High B-Glucan Cereals

(71) Applicant: Del Monte Foods, Inc., Walnut Creek, CA (US)

(72) Inventors: Loren L. Druz, Clayton, CA (US); Winston Lee, Hercules, CA (US); Jessica M. Widjaja, Moraga, CA (US); Parween Amiri, Dublin, CA (US); Corey Ewert, San Francisco, CA (US); Karim Nafisi-Movaghar, Walnut Creek, CA (US); Faris M. Elbadri, Walnut Creek, CA (US); Nathaniel A. Silva, Emeryville, CA (US); Frances M. Jin, Clayton, CA (US)

(73) Assignee: Del Monte Foods, Inc., Walnut Creek, CA (US)

(21) Appl. No.: 16/333,348

(22) PCT Filed: Oct. 3, 2018
(86) PCT No.: PCT/US2018/054169

§ 371 Date: Mar. 14, 2019

Related U.S. Application Data
(60) Provisional application No. 62/689,521, filed on Jun. 25, 2018.
(60) Provisional application No. 62/568,222, filed on Oct. 4, 2017.

(51) Int. Cl. A23B 9/30; A23B 7/157; A23L 7/117; A23L 19/00; A23L 2/02; A23L 2/68; A23L 2/66; A23L 2/44; A23L 33/19; A23L 25/00

(52) U.S. Cl. CPC A23B 9/30; A23B 7/157; A23L 7/117; A23L 19/03; A23L 19/09; A23L 2/02; A23V 2002/00; A23L 2/66; A23L 2/44; A23L 33/19; A23L 25/20; A23L 25/30; A23L 2/68

(57) ABSTRACT

High quality, portable, convenient, nutritious, packaged food products are provided, as well as processes for preparing packaged food products. Packaged food products comprise wet food systems of hydrated high β-glucan cereal acidified with acid or acid solutions having a pKa in a range of 1.9-2.2. This product can include non-citrus fruit, vegetable, and/or hydrated mucilaginous seeds mixed with hydrated, acidified high β-glucan cereal. Also, packaged food products comprise wet food systems of vegetable, or vegetable and non-citrus fruit acidified with acid or acid solutions having a pKa in a range of 1.9-2.2. This product can be packed in 100% juice or with other ingredients including sweeteners, flavors, and non-dairy milk, amongst others. High β-glucan cereal, non-citrus fruit, and/or vegetables formulated with packaged food products retain texture, flavor, color, and visual appearance after commercial processing and during storage.

### CROSS-REFERENCE TO RELATED APPLICATIONS

This application claims the priority and benefit of U.S. Provisional Patent Application Ser. No. 62/568,222, titled “Food Product and Processes for Its Preparation,” filed on Oct. 4, 2017, and of U.S. Provisional Patent Application Ser. No. 62/689,521, titled “Food Products and Processes,” filed on Jun. 25, 2018, the entireties of which are incorporated herein by reference.

### FIELD OF THE INVENTION

This disclosure relates to the formulation and manufacturing of portable, packaged, shelf-stable, ready-to-eat, commercial food products comprising water, acid or acid/salt mixtures, and one or more of: a high β-glucan cereal, non-citrus fruit, vegetable, and, optionally, one or more mucilage-containing seed. In particular, the cereals, non-citrus fruits and vegetables in this packaged food system substantially retain their flavor, color, texture, structure, and visual appearance, and remain flowable and do not congeal or spoil during storage for long periods of time.

### BACKGROUND

Consumers demand shelf-stable, healthy, on-the-go snacks, particularly those involving one or more of three nutritious ingredients: fruits, vegetables, and cereals. While packaged dried fruits, vegetables, cereals, and mixtures thereof are readily available, it is difficult to make long-lasting packaged wet food systems with these desirable ingredients that substantially retain their structural distinctiveness, texture, color, flavor, and appearance when stored for long periods of time. It is also difficult to make such a product that is ready to eat when the package is opened without further processing. One reason is that each of these nutritious ingredients, which are desired by consumers, has distinctly different processing requirements for commercial sterilization. A process suitable for one ingredient may negatively impact another; therefore, making it difficult to process them together in a liquid medium and deposit them into one packaged and ready-to-eat product such as “fruit and oats”, “fruit and vegetable”, “oats and vegetable”, “oats, fruit, and vegetable” or the like.

Another challenge is that cereals, especially those containing relatively high levels of β-glucan (e.g., oats and barley), are notoriously difficult to use in a wet food process because they become unstable or quickly congeal into unappetizing clumps after processing. In fact, it is difficult to make a commercially processed and packaged porridge or oatmeal product that only contains oats and water, or oats and milk, and that remains shelf-stable. Low acid cereals, such as oats, require significantly high thermal processing, e.g., F_{18/250}≥6, to reach commercial sterility. Excessive processing leads to loss of product texture, resulting in hydrated oats with an overly gummy texture that forms congealed globs or clumps, which negatively impact flavor, texture, and visual appearance. This renders the cereal unappetizing to consumers.

Of the few packaged wet oat products available on the market today, most are not ready to eat when opened and typically require additional preparation steps to make the product appealing to the consumer. These extra steps require, for instance, a consumer to mix the opened oats and water product (which is provided in an unappetizing brick-like form) with additional water and/or milk, and then stir the mixture, and is then followed by cooking or microwaving the oats to obtain a food product having flavor, texture, and visual appearance that a consumer would desire. Obviously, these additional steps also are less desirable for a consumer looking for a snack “on the go” who just wants to open the packaging and eat the product.

The difficulty of processing hydrated oat products is the result of the relatively high levels of β-glucan present in the oats, which is typically about 3-8% of the oats by weight. β-glucan is readily soluble in water. As a result, the presence of β-glucan in oats makes oats difficult to control because the soluble β-glucan causes thickening of the oats during and after processing. Such problems with regard to thickening can render the finished product excessively gummy, viscous, and/or formed into one or many clumps of congealed oats. This problem is exacerbated when the oats are finely ground (which allows for a higher surface area for absorption of water) and/or when the amount of oats in the packaged food product are higher than about 2% by weight.

While cereals with lower concentrations of β-glucan, e.g., rice, are easier to process, it is the difficult-to-process high β-glucan cereals such as oats and barley that are of higher interest to consumers because of their increased health benefits. Indeed, β-glucan is linked to specific physiological responses in humans, namely, lowering total and low-density lipoproteins (LDL) cholesterol and raising high-density lipoproteins (HDL) level. β-glucan can regulate glucose and insulin levels, as well as body weight. In addition to the benefits provided by β-glucan, oats are also considered to be a gluten-free cereal, making it nutritionally desirable for gluten-sensitive consumers.

Attempts have been made to reduce thermal processing of hydrated oat products for managing β-glucan, but have largely turned up unworkable. For example, it is known that the duration and/or temperature of thermal processing of packaged food products can be systematically reduced by reducing the pH of the products using acids. While an acid may reduce the pH of a hydrated oat product, the acid usually imparts a flavor (i.e., sourness) that is incompatible with the characteristic flavor of oats desired by consumers. Further, there is almost an infinite number of potential combinations of acids, oat systems, and thermal processing variables that make it difficult to find a specific thermal process for oats and acids suitable to make an appealing, shelf stable, ready-to-eat, packaged oatmeal or porridge.

Attempts have also been made to reduce the viscosity of β-glucan in a hydrated oat mixture using enzymes, but the listing of an enzyme in an ingredient legend of a consumer product is often perceived as an unnatural or undesireable ingredient by consumers, thereby negatively influencing the purchasing intent of the consumer. As a result, there is commercial need for enzyme-free processes and products.

While commercial processing of high β-glucan cereals is a known problem, combining high β-glucan cereals like oats with fruit is even more difficult because of different thermal processing requirements of oats, which are low acid, and fruits, which are naturally acidic. Applying thermal processing requirements for low acid oats (F_{18/250}≥6) in a fruit-oat system would make the fruit pieces soft and mushy. Within days or weeks after processing, the fruit pieces would lose their distinctive structure, texture, and integrity. This loss results from manufacturing processes for shelf stable or refrigerated products containing fruit, e.g., apples, peaches, and the like, which require milder processing conditions (typically F_{16/200}<0.1) to maintain the flavor, texture, and color of the fruit. However, applying thermal processing requirements typically used for fruits (F_{16/200}<0.1) would not be sufficient to sterilize the hydrated oats. Also, as discussed above, due to the presence of β-glucan, oats start gelling with moisture from the fruit and packing medium. The absorption of moisture from the fruit by β-glucan also leads to faster depletion of structure, texture, color, and integrity of the fruit pieces.

Similarly, it is difficult to combine vegetables and fruit in a liquid medium to create a packaged and shelf-stable product because thermal processing requirements for fruits and vegetables are different. Vegetables are low acid, in contrast to fruits which are naturally acidic; therefore, if vegetables and fruits are processed by thermal processing techniques used for low acid foods (F_{18/250}≥6), they lose their flavor, texture, and color. This renders the finished product soft, lacking desirable vegetable and fruit flavors, textures, and colors. While the flavor, texture, and color of shelf-stable mixtures of pieces of vegetable and fruit are degraded by excessive thermal processing, this degradation of quality is exacerbated because of the current, prevalent use of plastic, see-through packaging that is preferred by consumers for its visual appearance and portability, and by manufacturers for its lower costs. The use of plastic, see-through packaging instead of traditional metal can or container, results in slower heat transfer through the plastic packaging during thermal processing, and hence significantly more thermal energy and time is expended, causing the delicate ingredients of the food products to further degrade.

Accordingly, there is a specific need for creating packaged snacks containing water or a liquid medium, and one or more of a high β-glucan cereal, fruit, or vegetable, where the cereal, fruit, or vegetable substantially retain their structural distinctiveness, texture, color, flavor, and appearance when stored for long periods of time, and, are at the same time, appetizingly ready to eat without any further processing steps when the package is opened by a consumer.

Finding solutions for these problems is further complicated because packaged wet food systems and commercial sterilization processes are complex, often having unpredictable results coming from the physiochemical interactions between ingredients necessary to create the right shelf-stable combination of flavor, texture, color, and visual appearance desired by consumers. Therefore, a lot of experimentation would be needed to test various ingredient combinations that are viable not only from a technical and consumer need perspective, but that are also Generally Recognized As Safe (GRAS) under applicable food regulations.

### SUMMARY

It has been discovered after considerable experimentation that certain new and unique formulations involving certain acids not traditionally used with shelf-stable, ready-to-eat, formulations of fruits, vegetables, or cereal, when used with novel variations in the traditional commercial processing of these foods, can serve as a common solution to the problems discussed above. However, these solutions have been found to be applicable only to non-citrus fruits, vegetables, and high β-glucan cereals, where the β-glucan content in the cereal is at least 2 g per 100 g dry weight of cereal (i.e., 2% by dry weight), and at least 60% of the β-glucan in the cereal is water soluble. More specifically, it has been found that using an acid or acid/salt mixture with an effective pKa ranging from about 1.9-2.2 (wherein the acid/salt is preferably sodium bisulfate, or the acid/salt mixture is one or more of acids/salts selected from a group consisting of sulfuric acid, phosphoric acid, sodium bisulfate, potassium acid sulfate, monosodium phosphate, or monopotassium phosphate, or, alternatively, salts or esters of gluconic acid, preferably glucono delta-lactone (GDL), along with innovative variations in commercial processing including: (i) pre-thermal processing step(s) of: (a) partially hydrating and acidifying the cereal, and/or (b) adding mucilaginous seeds having high mucilage content (especially chia seeds or basil seeds), or (ii) combining vegetables and fruit in packaged wet food systems that equilibrate in situ within 24 hours (or less) after commercial processing, can be used to develop portable, convenient, nutritious, shelf-stable, ready-to-eat, packaged food products such as, but not limited to, the following:
(a) A hydrated oat or barley product, which remains flowable and does not congeal when stored for long periods of time, but is still ready-to-eat when opened without the need for additional preparation steps (e.g., adding liquids such as water or milk, or heating);
(b) A shelf-stable, portable, convenient, nutritious and ready-to-eat oat or barley product, with chia seed, basil seed, or any other mucilaginous seed, and, optionally, with vegetables and non-citrus fruits, and preferably, where the mucilaginous seed contains mucilage that is at least 7 g per 100 g of the dry weight of the seed, and the seed can also absorb at least 10 times its dry weight in water;
(c) A packaged oat or barley product with non-citrus fruits and/or vegetables;
(d) A packaged drinkable oat product with non-citrus fruit and/or vegetables that has a sufficiently high percentage of oats, that allows a consumer to taste and feel the oat flavor and oat texture of the product;
(e) A vegetable and non-citrus fruit product, predominantly containing vegetable pieces with added fruit pieces, packed in 100% juice and/or sugar or sweetener solutions for flavor, that provides more than one serving of combined vegetables and non-citrus fruits in a container; and
(f) A vegetable product, containing vegetable pieces, packed in fruit and/or vegetable juice, providing at least one serving of vegetables in a container.

### DESCRIPTION OF THE FIGURES

Additional aspects, features, and advantages of the invention, as to its operation, will be understood and will become more readily apparent when the invention is considered in light of the following description of illustrative embodiments made in conjunction with the accompanying figures, wherein:

FIG. 1 illustrates a process of the invention useful for making a shelf-stable, packaged food product with hydrated high β-glucan cereal, i.e., oats, and hydrated mucilaginous seeds, i.e., chia seeds. The process includes using thermal processing (e.g., F_{16/200}≥0.1-181° F. for about 42 minutes) to prepare the shelf-stable, packaged food product comprising hydrated oats acidified with sodium bisulfate to a pH of about 4.6 or less, and mixed with hydrated chia seeds, also acidified with sodium bisulfate and other ingredients (e.g., sweeteners, salt, flavor, spice, juice, color, others nuts/seeds, non-dairy milk, or ascorbic acid, or any combination thereof), and, optionally, non-citrus fruit (up to about 33% of the food product), vegetable, or predominantly vegetable and non-citrus fruit. The hydrated oats and chia seeds and optional non-citrus fruit and/or vegetables retain flavor, color, texture, structure, and visual appearance after exposure to thermal processing.

FIG. 2 illustrates a process of the invention useful for making a pasteurized, packaged food product with hydrated high β-glucan cereal, i.e., oats, and hydrated mucilaginous seeds, i.e., chia seeds. The process includes using HPP processing (e.g., 400-600 mPa for about 1-5 minutes) to prepare the pasteurized, packaged food product (which must be refrigerated) comprising hydrated oats acidified by sodium bisulfate to a pH of about 4.6 or less, and mixed with hydrated chia seeds, also acidified with sodium bisulfate, and other ingredients (e.g., sweeteners, salt, flavor, spice, juice, color, others nuts/seeds, non-dairy milk, or ascorbic acid, or any combination thereof), and, optionally, non-citrus fruit (e.g., about 33% or less of the packaged food product). The hydrated oats and chia seeds and optional non-citrus fruit retain flavor, color, texture, structure, and visual appearance after exposure to the HPP processing.

FIG. 3 illustrates a process of the invention useful for making a pasteurized, packaged food product with hydrated high β-glucan cereal, i.e., oats, and hydrated mucilaginous seeds, i.e., chia seeds. The process includes using minimal thermal processing (e.g., F_{16/160}=1.0) to prepare the pasteurized, packaged food product (which must be refrigerated) comprising hydrated oats acidified by sodium bisulfate to a pH of about 4.6 or less, and mixed with hydrated chia seeds, also acidified with sodium bisulfate, and other ingredients (e.g., sweeteners, salt, flavor, spice, juice, color, others nuts/seeds, non-dairy milk, or ascorbic acid, or any combination thereof), and, optionally, non-citrus fruit (up to about 33% of the food product). The hydrated oats and chia seeds and optional non-citrus fruit retain flavor, color, texture, structure, and visual appearance after exposure to the minimal thermal processing.

FIG. 4 illustrates a process of the invention useful for making a shelf-stable, packaged food product with vegetables and topping solution acidified in situ. The process includes using thermal processing (e.g., F_{16/200}≥20-222° F. for about 11 minutes) to prepare the shelf stable, packaged food product comprising fresh, drained, canned, or thawed (previously frozen) vegetables (e.g., corn, carrot, sweet potato, green bean, peas) mixed with solutions of other ingredients (e.g., sweetener, salt, flavor, spice, juice, color, or ascorbic acid, or any combination thereof) and sodium bisulfate so that the food product is acidified to a pH of about 4.6 or less by about 24 hours (or less) after thermal processing. The vegetable retain flavor, color, texture, structure, and visual appearance after the thermal processing.

FIG. 5 illustrates a process of the invention useful for making a shelf-stable, packaged food product with predominantly vegetable and lesser amount of non-citrus fruit and topping solution acidified in situ. The process includes using thermal processing (e.g., F_{16/200}≥20-222° F. for about 11 minutes) to prepare a shelf stable, packaged food product comprising fresh, drained, canned, or thawed (previously frozen) vegetables (e.g., corn, carrot, sweet potato, green bean, peas) and fresh, drained, canned, thawed, or frozen non-citrus fruit (e.g., peach, mango, pear, pineapple, apple) mixed with solutions of other ingredients (e.g., sweetener, salt, flavor, spice, juice, color, or ascorbic acid, or any combination thereof) and sodium bisulfate so that the food product is acidified to a pH of about 4.6 (or less) by about 24 hours after thermal processing. The vegetable and non-citrus fruit retain flavor, color, texture, structure, and visual appearance after thermal processing.

FIG. 6 illustrates a process of the invention useful for making a shelf-stable, packaged food product with high β-glucan cereal grain, e.g., barley or oats, hydrated mucilaginous seeds, e.g., basil seeds or chia seeds, and vegetables. The process includes using thermal processing (e.g., F_{16/200}≥0.1-181° F. for about 42 minutes) to prepare the shelf stable, packaged food product comprising fresh, drained, canned, cooked, or thawed (previously frozen) vegetables (e.g., corn, carrot, sweet potato, green bean, peas) acidified with sodium bisulfate or acid solution of this invention, hydrated grains acidified with sodium bisulfate or acid solution of this invention, hydrated chia seeds, also acidified with sodium bisulfate, and other ingredients (e.g., salt, flavors, spices, juices, sweeteners, vinegars, purees, color, oil, non-dairy milk, or ascorbic acid, or any combination thereof) mixed and portioned into containers for thermal processing. The cereal grain and vegetables retain flavor, color, texture, structure, and visual appearance after thermal processing.

FIG. 7 illustrates a process of the invention useful for making a shelf-stable, packaged food product with high β-glucan cereal, e.g., barley or oats, and non-citrus fruit. The process includes using thermal processing (e.g., F_{16/200}≥0.1-181° F. for about 42 minutes) to prepare the shelf stable, packaged food product comprising hydrated oats acidified with sodium bisulfate or acid solution of the invention to a pH of about 4.6 or less, and optional non-citrus fruit (e.g., about 33% or less of the packaged food product) and other ingredients (e.g., sweetener, salt, flavor, spice, juice, color, other seeds, nuts, non-dairy milk, or ascorbic acid, or any combination thereof). The hydrated oats and optional non-citrus fruit retain flavor, color, texture, structure, and visual appearance after thermal processing.

### DETAILED DESCRIPTION OF EMBODIMENTS OF THE INVENTION

Illustrative and alternative embodiments and operational details of packaged food products comprising vegetables, non-citrus fruit, high β-glucan cereal (i.e., oats or barley), and/or mucilaginous seeds (i.e., chia seeds or basil seeds), or any combination thereof, treated with, or exposed to, sodium bisulfate or other acid solution disclosed with this invention, as well as processes for preparing such packaged food products, are discussed in further detail in this disclosure with reference to the figures.

### Definitions

“Basil seed” refers to seeds obtained from the sweet basil plant Ocimum basilicum. The basil seed is tiny, black, and ellipsoidal, and has mucilage adhered to the seed within the outer pericarp of the seed. Mucilage of a basil seed ranges from about 7-22 g per 100 g of dry basil seed (i.e., about 7-22% by dry weight of basil seed), depending upon the genus. Basil seed mucilage acts as a reservoir to hold loosely bound water at a high water potential. A single basil seed can absorb up to about 30 times its dry weight in water.

“Barley” refers to a type of high β-glucan cereal grain obtained from the grass Hordeum vulgare. Barley is high in carbohydrates, dietary fiber, and antioxidants; is a source of protein; and is low-fat and cholesterol-free.

“Chia seed” refers to seeds obtained from the plant Salvia hispanica L. The chia seed is small and oval shaped with brown, gray, black, or white color, and has mucilage localized in the cellular structures of the first three layers of the seed coat. The mucilage of chia seed ranges from about 9-10 g per 100 g of dry chia seed (i.e., about 9-10% by dry weight of chia seed). Chia seed mucilage acts as a reservoir to hold loosely bound water at a high water potential. A chia seed can absorb up to about 12 times its dry weight in water.

“Commercial processing” refers to any type of thermal or non-thermal treatment used to sterilize food products before (or after) packaging and distribution in commerce. The thermal and non-thermal treatments include, but are not limited to, retort processing for pasteurization or sterilization, aseptic processing, microwave assisted thermal sterilization (MATS), high-pressure processing and ultra-high-pressure processing (HPP/UHP), and high-intensity light pulse (HILP). Commercial processing expressly excludes home-made, chef recipes, and the like that are primarily intended to be used or sold for immediate or near-term consumption at homes and restaurants, and where the prepared food would start to spoil or become unsafe to consume after (a) about 2 months or longer if stored at ambient temperature, or (b) about 4 months or longer if stored under refrigerated conditions.

“Container” refers to a receptacle made from a food-safe material suitable for commercial processing such, as for example, at least one of metal, glass, and/or plastic. Container types can include, but are not limited to, a cup, a can, ajar, a flexible bag or pouch with an opening sealed with a lid, top, or a flexible film cover, or the like. The flexible film is also made from a food-grade plastic or other acceptable food-grade material.

“High β-glucan cereal” or “High β-glucan cereal grain” refers to the edible components of the grain of cultivated grass, composed of the endosperm, germ, and bran, which are rich in the water-soluble fiber, β-glucan. Such high β-glucan cereals and grains are, for example, barley, and oats. Among high β-glucan cereals, barley contains about 2-20 g of β-glucan per 100 g dry weight of barley (i.e., about 2-20% by dry weight) with up to about 60% of the β-glucan being water-soluble fraction, while oats contains about 3-8 g of β-glucan per 100 g dry weight of the oats (i.e., about 3-8% by dry weight) with up to about 80% of the β-glucan being water-soluble.

“Hydrate” or “Hydrated” refers to causing a food ingredient, e.g., mucilaginous seed or high β-glucan cereal grain, to absorb water, or a food ingredient that has absorbed water at some amount up to the food ingredient's maximum water absorption capacity. By way of example, and not a limitation, a mucilaginous seed or high β-glucan cereal grain can be partially hydrated at any amount less than its maximum absorptive capacity, or fully hydrated up to about its maximum physical absorptive capacity.

“Mucilaginous seed” refers to an edible embryonic plant(s) or seed(s) enclosed in a protective outer covering having mucilage. Mucilage is a biopolymer that is a viscous, soluble fiber containing protein and polysaccharides, such as, for example, xylose, arabinose, rhamnose, galactose, and glucose. Mucilage plays a role in the storage of water and thickening of membranes of the seed and forms a gelatinous substance when it is hydrated. A hydrated mucilaginous seed has a hull enclosed in a sack of gelatinous matrix. Examples of mucilaginous seeds include, but are not limited to, chia seeds and basil seeds. Without being limited to any theory or mode of operation, hydrated mucilaginous seeds can be used as a hydrocolloid in the packaged wet food systems of this invention.

“Non-dairy milk” refers to any milk obtained or derived from plants. Examples of non-dairy milk include, but are not limited to, almond milk, coconut milk, or rice milk.

“Non-citrus fruit” refers to any fruit that is not a citrus fruit. For reference, a citrus fruit is produced by flowering trees and shrubs in the genus of the rue family, Rutaceae, and includes, for example, lemons, limes, oranges, and the like. By way of example, and not a limitation, non-citrus fruits include, but are not limited to, apples, apricots, bananas, blackberries, blueberries, cherries, cranberries, dragon fruit, grapes, gooseberries, kiwi, mangos, nectarines, peaches, pears, pineapple, plum, raspberries, strawberries, and the like. The non-citrus fruit will be previously harvested, cleaned, and prepared, and can be fresh, drained, canned, or thawed (frozen).

“Oats” refers to a type of high β-glucan cereal grain obtain from the grass Avena sativa. Oats have water-soluble β-glucan in the outer layers of the endosperm of the oats. As used in the invention, oats can include, but are not limited to, unprocessed oats, whole grain oats, rolled oats (old fashion or traditional), instant oats, steel cut oats, groats, ground oats, bumped (cracked) oats, or comminuted oats. Rolled oats are whole groats (husk removed) are flattened to a certain thickness. Steel cut oats are whole groats (husk removed) cut into pieces.

“Oat taste” refers to the distinct taste of prepared oats, as determined by a majority (>50%) vote of a panel of at least 30 reasonable consumers after an independently administered taste test.

“Oat texture” refers to the distinct texture of prepared oats, as determined by a majority (>50%) vote of a panel of at least 30 reasonable consumers after an independently administered taste test.

“Packaged food product” refers to a commercially processed, shelf-stable, and ready-to-eat food product that has been placed and sealed in a container in a sterile environment, and is ready to be transported, stored, and distributed in commerce. In the context of this invention, the packaged food product includes a wet food system (i.e., any product containing water, syrup, juice or other liquids that are distinctly perceived or felt as moist). Packaged food products may also be referred to as a packaged wet food systems.

“Ready-to-eat” or “ready-to-eat food” refers to a commercially processed food, for which it is reasonably foreseeable that a consumer will eat the food after opening a container of the food, without need to further process the food, such as, adding ingredients, mixing, heating, or cooking the food.

“Shelf stable” or “shelf stable food” generally refers to a food that is commercially processed and that can be safely stored at room temperature in a sealed container. This includes foods that would normally be stored refrigerated, but which have been processed so that they can be safely stored at room or ambient temperature for a usefully long shelf life. In the context of this invention, a food is considered shelf stable if it can last without spoilage (a) about 2 months or longer if stored at ambient temperature, or (b) about 4 months or longer if stored under refrigerated conditions.

“Sodium bisulfate” refers to the sodium salt of the bisulfate anion with the molecular formula NaHSO₄. Sodium bisulfate is an acid salt formed by partial neutralization of sulfuric acid by an equivalent of sodium base, typically either in the form of sodium hydroxide or sodium chloride. Sodium bisulfate is a dry granular product, i.e., white to off-white odorless granules, that can be safely shipped and stored. Sodium bisulfate is hygroscopic and is readily soluble in water. Sodium bisulfate has a pH of approximately 1 in a 5% aqueous solution. Sodium bisulfate has an acidity, i.e., pKa, of approximately 1.99. Sodium bisulfate is also referred to as bisulfate of soda, sodium acid sulfate, monosodium hydrogen sulfate, sodium hydrogen sulfate, sodium hydrosulfate, and sulfuric acid mono sodium salt.

“Spice” refers to any aromatic vegetable substance in the whole, broken, or ground form, except for those substances that have been traditionally regarded as foods, such as onions, garlic and celery; whose significant function in food is seasoning rather than nutritional; that is true to name; and from which no portion of any volatile oil or other flavoring principle has been removed. Spice can include any one of the following: allspice, anise, basil, bay leaves, caraway seed, Cardamon, celery seed, chervil, cinnamon, cloves, coriander, cumin seed, dill seed, fennel seed, fenugreek, ginger, horseradish, mace, marjoram, mustard flour, nutmeg, oregano, paprika, parsley, pepper, black; pepper, white; pepper, red; rosemary, saffron, sage, savory, star aniseed, tarragon, thyme, and turmeric.

“Sweetener” refers to any natural or artificial substance used to sweeten food or drink including sugar. Examples of artificial sweeteners include, but are not limited to, acesulfame potassium, aspartame, saccharin, and sucralose. Examples of natural sweeteners include, but are not limited to, agave nectar, date sugar, fruit juice, honey, maple syrup, and molasses. Other sweeteners include, for example, corn syrup, high fructose corn syrup, refined sugar, Stevia extract, and polyols (sugar alcohols).

“Texture” or “food texture” refers to the rheological and structural (geometrical and surface) attributes of a food product that are perceptible by sensory experiences originated from receptors of humans during the eating process of the food. Texture and structure are internally linked properties of food products. Food texture largely correlates with the oral sensory perception of humans while eating, primarily in the form of biting, chewing, etc., that involves deformation, flow, fracturing, and breaking of food. Texture is interpreted by the brain from oral sensation of the food's responses and resistances against such deformations. Texture provides sensory “mouth feel” which, for example, can be described in terms such as, but not limited to, hard, soft, liquid, solid, rough smooth, creamy, crumbly, crispy, lumpy, gritty, etc. These terms relate directly to the density, viscosity, surface tension, and other physical properties of a food product, which relate to its physical structures and mechanical properties. Texture is a key quality parameter used to assess preference and acceptability of a food product by consumers, who use texture to determine the quality and/or freshness of a food product, especially fruits and/or vegetables. Texture directly affects repeat purchase of a food product by consumers, and, consequently, the market value of the food product.

“Thermal processing” refers to a process by which a commercial packaged food product, such as a mixture of food ingredients, are heated at temperatures of at least 175 degrees F. The process can be identified by a measurable sterilization value that can kill C. botulinum in low acid. In thermal processing, the objective is to increase the temperature of the food to reduce the target agent (typically microorganisms or their spores) to an acceptable level. Blanching, pasteurization (i.e., elimination of vegetative pathogenic microorganisms) with subsequent refrigeration, and sterilization (i.e., reduction of heat-resistant spores to acceptable levels resulting in long shelf-life, such as two years at room temperature) can be used depending on the severity of heating. The quicker the cold point of food reaches the desired process temperature and the quicker it is cooled to ambient temperature, the shorter the overall process, and, consequently, the better the quality retention of flavor, texture, color, nutrients, and visual appearance in the food product.

“Visual appearance” refers to the impression created by a food product that is sensed by the eye of a consumer. Many individual factors contribute to the total perception of the appearance of a food product, e.g., shape, color, opacity, translucency, gloss, and the consistency of any one or more of these factors. The total perception correlates with all the visual sensations experienced when a food product is viewed on the shelf and presented, prior to it being consumed. The visual appearance of a food product plays a significant role in a consumer's willingness to accept a food product.

### I. Overview of the Invention for Packaged Food Products

According to the invention, packaged food product formulations and processes are provided and include specific ingredients in combinations, e.g., vegetable, vegetable with non-citrus fruit, high β-glucan cereals (e.g., oat or barley), and/or mucilaginous seeds (e.g., chia seeds or basil seeds), or any combination thereof (as disclosed in this application), as well as sodium bisulfate (or other disclosed acid) used in the processes to manufacture the packaged food products of this invention.

There are benefits of using sodium bisulfate according to this invention. Without being limited to any theory or mode of operation, sodium bisulfate in specific formulations of packaged food products: (i) improves manufacturing processes by assisting in reduction of time and temperature used in commercial processing, (ii) creates packaged food products having extended shelf life, (iii) serves as a flavor enhancer for packaged food products, (iv) is economical, e.g., inexpensive, and is Generally Recognized as Safe (GRAS) for human consumption by food regulatory authorities (e.g., U.S. Food and Drug Administration). Sodium bisulfate is preferred in the operation and use of the invention; however, any acid or acid solution having an effective pKa value from about 1.9-2.2 is also operable with the theory of the invention. By way of example, and not a limitation, any acid or soluble acid salt selected from sulfuric acid, phosphoric acid, sodium bisulfate, potassium acid sulfate, monosodium phosphate, or monopotassium phosphate, or, alternatively, salts or esters of gluconic acid preferably GDL, either alone or in combination, is effective with the concept of the invention. For example, the acid or acid solution could be a combination of sodium bisulfate with any one or more of sulfuric acid, phosphoric acid, ascorbic acid, potassium acid sulfate, monosodium phosphate, monopotassium phosphate, or gluconic acid.

There are also benefits of using mucilaginous seeds according to the invention. Highly-hydrophilic mucilaginous seeds, when hydrated, provide a hydrocolloid that facilitates flowability of specific formulations of packaged food products.

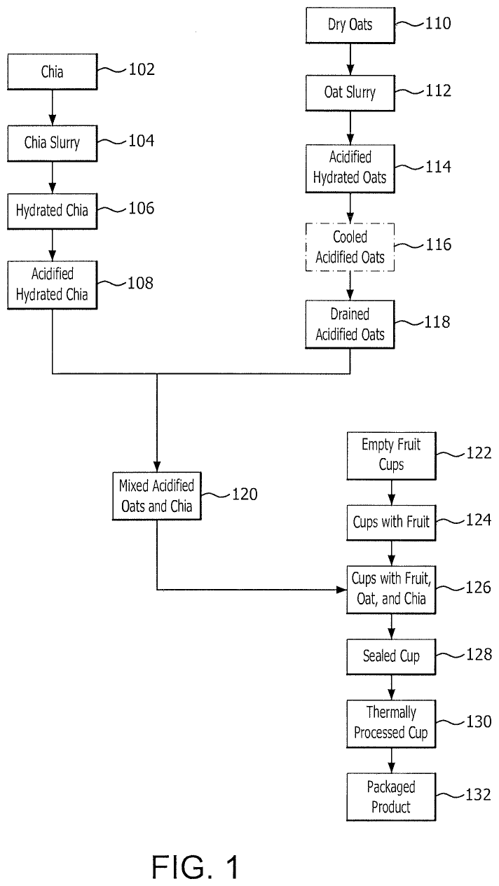

In summary, and as disclosed in further detail, the invention includes formulations of packaged food products (see, e.g., Examples 1-20), as well as processes for preparing the formulations of packaged food products (see, e.g., FIGS. 1-7) that have preserved flavor, texture, color, and visual appearance, which are characteristics desired by consumers.

A. Sodium Bisulfate in Soaking Solution to Control β-Glucan of High β-Glucan Cereals, and to Retain Flavor, Texture, Color, and Visual Appearance of the Packaged Food Products after Commercial Processing

It has been determined that sodium bisulfate has physiochemical and reactive qualities that make it an optimal reactant and acidulant when used in a soaking solution for treating high β-glucan cereal grains (e.g., oats or barley) before commercial processing, preferably in connection with the step of soaking high β-glucan cereal grains 112/114, 210/214, 310/314 to hydrate and acidify them according to processes of the invention (see FIGS. 1-3).

Without being limited to any theory or mode of operation, sodium bisulfate can (i) chemically modify β-glucan present on the surface of high β-glucan cereal grain by hydrolysis, (ii) promote solubilization of β-glucan present in the cereal grain, and (iii) remove excess β-glucan from the cereal grain. β-glucan is a water soluble, structural (non-starch) polysaccharide composed of d-glucose with β-(1→3) and β-(1→4) glycosidic linkages in high β-glucan cereal grain, e.g., oats, shown as follows:

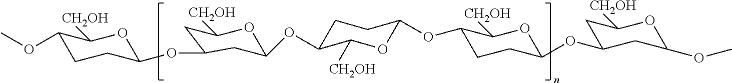

Hydrolysis of β-glucan with sodium bisulfate decreases the viscosity of hydrated high β-glucan cereal grain, along with solubilization and removal of the β-glucan from the cereal grain. This contributes to the reduction and viscosity control of β-glucan, which consequently prevents high β-glucan cereal grain from congealing into globs or clumps after the treated cereal grain undergo commercial processing.

Sodium bisulfate can also be used to acidify high β-glucan cereal grain to a desired pH, e.g., about 4.6 or less, without imparting a sour taste. Referring to FIGS. 1-3, acidification occurs while the high β-glucan cereal grain are soaking in the wash or soaking solution (e.g., water and sodium bisulfate) to become hydrated 112/114, 210/214, 310/314, for example, until the cereal grain are fully hydrated (e.g., about 90-100% water by weight of pretreated grain) or partially hydrated (e.g., about 40-90% or less of pretreated grain) or preferably about 60-80%. Since oats have a potential for water absorption of about 20-250% by weight, this moisture content can be adjusted as needed as one skilled in the art would appreciate. Pretreated oats have a moisture content of about 0-15%. Without being limited to any theory or mode of operation, the acidification of high β-glucan cereal grain with sodium bisulfate in a wash or soaking solution, also, contributes to reduction and viscosity control of the β-glucan. After the high β-glucan cereal grain are sufficiently acidified and hydrated, the soaking solution with sodium bisulfate is removed 118, 218, 318 from the high β-glucan cereal grain (see, e.g., FIGS. 1-3). Some residual sodium bisulfate can remain on the surface of high β-glucan cereal grain as an acidulant in packaged food products, the benefits of which are subsequently described. Hydrated and acidified high β-glucan cereal grain may, optionally, be rinsed with fresh water to optionally cool the cereal grain 116, 216, 316 and to remove excess β-glucan, further controlling viscosity of β-glucan remaining in the cereal grain.

Acidification of hydrated high β-glucan cereal grain with sodium bisulfate improves conditions used for commercial processing. Indeed, the favorable pH reduction permits use of commercial processing conditions that are milder than those conditions used in traditional commercial processing. These mild conditions facilitate preservation of flavor, texture, color, and visual appearance of the hydrated and acidified high β-glucan cereal grain, as well as any fruit and/or vegetables (if present) in the packaged food products.

B. Sodium Bisulfate as an Additive to Retain Flavor, Texture, Color, and Visual Appearance of the Ingredients of Packaged Food Products after Commercial Processing

The physiochemical and reactive qualities of sodium bisulfate make it an optimal food additive, e.g., an acidulant, in packaged wet food systems of this invention.

Sodium bisulfate is a preferred additive for packaged food products containing fruit and/or vegetable because it can be used to acidify the components of the wet food system in the packaged food product. The pH of the wet food system reaches equilibrium in the container within about 24 hours (or less) after commercial processing. Sodium bisulfate is generally preferred in the various aspects of the compositions and processes of the invention. However, an acid or acid mixture having an effective pKa value ranging from about 1.9-2.2 that is Generally Recognized As Safe (GRAS) for human consumption could also be used. More specifically, an acid or acid mixture selected from the following list also meets the mode of operation of the processes of the invention: sulfuric acid, phosphoric acid, sodium bisulfate, potassium acid sulfate, monosodium phosphate, or monopotassium phosphate, or, alternatively, gluconic acid. Conversely, certain food grade acids, such as lactic acid, propionic acid, etc., do not work with the mode of operation of the invention because these acids diminish flavor, texture, color, and visual appearance of non-citrus fruit and/or vegetable combined with and/or suspended in solutions of the wet food systems of the invention, which, optionally, could include hydrated high β-glucan cereal grain (e.g., oats or barley).

Sodium bisulfate can be used to reduce the pH of non-citrus fruit and/or vegetable in the packaged food product, which as previously discussed, facilitates improved treatment conditions over those used in traditional commercial processing that acidifies vegetables by acid blanching or soaking in acid solutions (i.e., citric or lactic acid) before processing. The improved conditions mitigate known problems caused traditional commercial processing, such as, for example, loss of flavor, texture, color, and visual appearance, resulting from longer processing times. Furthermore, sodium bisulfate, optionally at lower amounts, can be combined with an organic acid (i.e., ascorbic acid) found naturally in a 100% fruit or juice medium to reduce the harshness of commercial processing conditions on the components of packaged food products. For example, juice contributes its natural acidity, sweetness, and flavor (fruit and/or vegetable), which helps balance any tartness in the packaged food product. Moreover, acidification of low acid vegetable or fruit pieces can also be achieved by blanching the pieces in acid solutions of the invention, and, then, combining the blanched pieces with other naturally acidic fruit pieces prior to filling them into a container, and then topping them with a packing medium with 100% juice (fruit and/or vegetable) and acid, e.g., sodium bisulfate, or acid solution of the invention.

Sodium bisulfate used as a food additive does not impart significant sourness or tartness (e.g., sodium bisulfate is less tart/sour than citric acid) to the components in the package food products. This benefit avoids disruption of the gustatory perception of other components in a wet food system, e.g., non-citrus fruit, vegetable, chia seeds, high β-glucan cereal, and juice, which occurs with the use of other acids, such as, citric acid.

C. Mucilaginous Seeds Provide Hydrocolloids that Modulate β-Glucan of the Hydrated and Acidified High β-Glucan Cereal Grain in Packaged Food Products

Another feature of the invention is the use of mucilaginous seeds (e.g., chia seeds or basil seeds) as a hydrocolloid in certain packaged food products. In aspects of the invention (see, e.g., FIGS. 1-3), hydrated (and optionally acidified) mucilaginous seeds (e.g., chia seeds or basil seeds) 108, 208, 308 can be mixed 120, 220, 320 with hydrated and acidified high β-glucan cereal grain (e.g., oats or barley) to reduce or eliminate β-glucan migration in the wet food system of the packaged food product. Without being limited to any theory or mode of operation, highly-hydrophilic mucilaginous seeds become a hydrocolloid when hydrated and provide at least two functions in the packaged wet food systems of the invention: (1) hydrated mucilaginous seeds provide a slippery, gelatinous matrix forming a barrier between hydrated high β-glucan cereal grain dispersed within the hydrocolloid of the hydrated mucilaginous seeds, and (2) the highly-hydrophilic mucilaginous seeds control and balance water migration within the wet food system of the packaged food product.

Since mucilaginous seeds are more hydrophilic than cereal grain and can absorb water from the cereal grain, as well as any excess water in a wet food system of a packaged food product, mucilaginous seeds make the hydrated and acidified high β-glucan cereal grain less sticky, preventing coagulation of the cereal grain, and maintaining their viscosity, e.g., flowability, in the wet food system of the packaged food product. This prevents the hydrated and acidified high β-glucan cereal grain from forming an overly gummy texture, and thickening and congealing into one or more globs or clumps.

Mucilaginous seeds can be used in the invention to create packaged food products having high β-glucan cereal grain, or packaged food products having high β-glucan cereal grain mixed with non-citrus fruits, vegetables, or non-citrus fruits and vegetables (see, e.g., FIGS. 1-3).

Another benefit of mucilaginous seeds is their health-promoting characteristics, such as, for example, omega-3 fatty acids, iron, and calcium.

II. Processes Using Sodium Bisulfate as a Soaking Solution in Manufacturing Packaged Food Products with Hydrated and Acidified High β-Glucan Cereal Grain, Hydrated and Acidified Mucilaginous Seeds, and/or Non-Citrus Fruit and/or Vegetables

Referring generally to FIGS. 1-3, this invention provides improved processes for manufacturing packaged food products having high β-glucan cereal grain (e.g., oats or barley) soaked with sodium bisulfate or other acids of the invention to acidify and hydrate the cereal grain to optimize the level of β-glucan of the cereal grain in packaged food products.

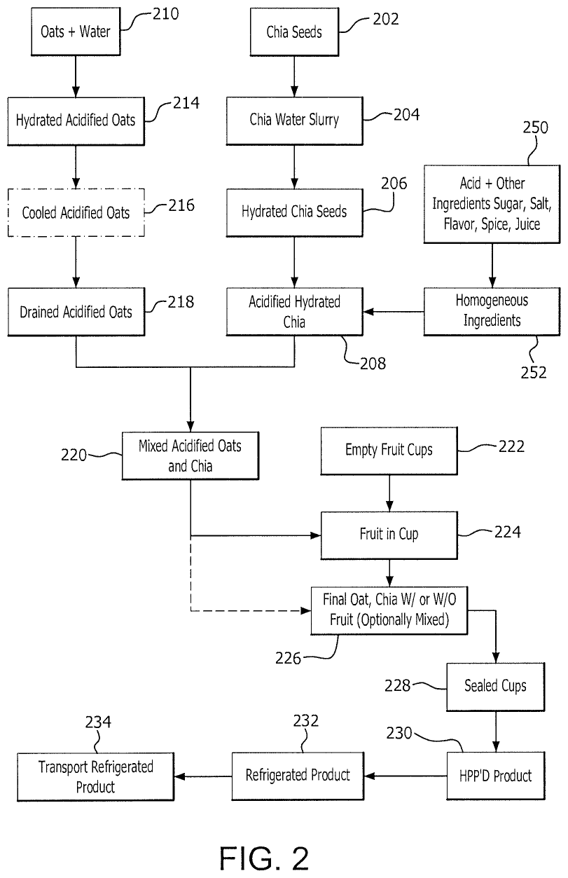

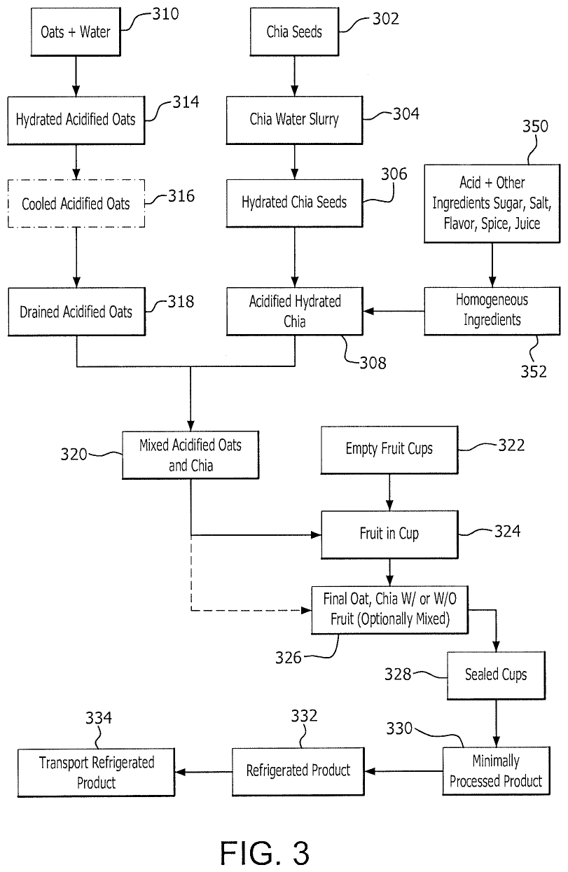

Embodiments of the processes of the invention illustrated in FIGS. 1-3 generally include the following steps: (1) washing and/or soaking 112/114, 210/214, 310/314 high β-glucan cereal grain (e.g., oats or barley) in a water-based solution acidified with sodium bisulfate to hydrate the cereal grain and acidify them to a pH of about 4.6 or less, (2) soaking mucilaginous seeds (e.g., chia seeds or basil seeds) in water 104, 204, 304 to hydrate 106, 206, 306 the mucilaginous seeds and optionally to acidify the hydrated mucilaginous seeds 108, 208, 308 to a favorable pH (e.g., 4.6 or less), (3) mixing the hydrated and acidified cereal grain with the hydrated (optionally acidified) mucilaginous seeds 120, 220, 320 and portioning the mixture (i.e., wet food system) into containers 126, 224/226, 324/326 that are later sealed 128, 228, 328 and commercially processing the sealed containers according to the invention (e.g., FIG. 1 (thermal processing 130); FIG. 2 (high pressure processing 230), and FIG. 3 (minimal thermal processing 330)).

Formulations of packaged food products made according to the foregoing processes include certain combinations of hydrated and acidified high β-glucan cereal grain with components such as, mucilaginous seeds (e.g., chia seeds or basil seeds) used as a hydrocolloid to disperse the hydrated and acidified cereal grain in a ready-to-eat products that can be shelf stable, whether unrefrigerated or refrigerated, for longer periods of time that are currently possible. The invention also includes the addition of other ingredients such as, distinct pieces of edible non-citrus fruit or vegetable, including non-citrus fruit or vegetable that has not been dried or dehydrated. Novel formulations are provided for packaged food products (see, e.g., Examples 1-9) that have flavor, color, texture, structure, and visual appearance preferred by customers.

A. Soaking High β-Glucan Cereal Grain in an Acid Solution to Hydrate and Acidify the Cereal Grain to Optimize Soluble β-Glucan Activity in Wet Food Systems of Packaged Food Products

Referring to FIGS. 1-3, the process includes the step of soaking high β-glucan cereal grain (e.g., oats or barley) in water 112/114, 210/214, 310/314 acidified with sodium bisulfate to hydrate the oats and acidify them to a target pH (e.g., about 4.6 or less). This step 114, 214, 314 optimizes the β-glucan present in the cereal grain by reducing and controlling β-glucan viscosity with hydrolysis, and solubilizing β-glucan present in the cereal grain.

The invention operates not only with cut or finely ground oats that can be used to make a drinkable oats product (with a generally lower percentage of oats by weight in the packaged food product), but also with coarser or even uncut (i.e., whole grain) oats that provide a higher concentration of oats in the packaged food product that may have an oatmeal or porridge consistency. It is known that coarser oats and/or higher concentration of oats in packaged food products are significantly more difficult to work with because the soluble β-glucan coagulates in commercial packaged products, particularly after long term refrigeration or non-refrigerated storage. This invention overcomes the foregoing issues and allows for use of high concentrations of oats (or barley), which can be whole, coarse, or cut, in packaged food products.

This invention overcomes the foregoing issues and allows for use of high concentrations of oats (or barley), which can be whole, coarse, or cut, in packaged food products. Oats of a wide range of sizes can be used with this invention. Generally, the applicable size is about 0.003-0.26 inches, though the preferred range is about 0.005-0.2 inches. For rolled oats (groats), the preferred thickness range is about 0.005-0.1 inches. For steel cut oats, the preferred lengths include about 0.05-0.2 inches.

Referring to FIGS. 1-3, the step of soaking oats 114, 214, 314 comprises immersing the oats in water mixed with a certain type of food-grade, GRAS acid or acid salt at a ratio of oats to water at the target temperature for a duration of time. In an embodiment, the preferred acid is sodium bisulfate. The acid can also be sulfuric acid, phosphoric acid, potassium acid sulfate, monosodium phosphate, or monopotassium phosphate, or their salts, or other bisulfates of alkali or alkaline earth metals, or alternatively, gluconic acid. The acid can be combined with other acids mixed in the water. It is preferred that the acid or acid mixture be strongly acidic (i.e., having an effective pKa value ranging from about 1.9-2.2), and selected and used at a concentration so as not to impart a sour taste on the hydrated oats. There are many acids commonly used in food processing that do not meet the criteria for the mode of operability of the invention. For example, citric acid is not useful for the invention because it imparts a sour taste in the food that it contacts. Also, ascorbic acid alone does not meet the mode of operability of the invention, but ascorbic acid may be used in combination with sodium bisulfate to reduce the amount of sodium bisulfate, but only in amounts sufficient to serve as a preservative of the color of any non-citrus fruit or vegetable that may be incorporated into the packaged food product.

During the soaking step 112/114, 210/214, 310/314 (see FIGS. 1-3), the oats are acidified by exposure to the acid or solubilized acid salt at a concentration that promotes acid hydrolysis of the β-glucan of the oats. The acid is selected and used at a concentration that provides the soaking solution, e.g., water, with a pre-soak pH in a range of about 1.55-1.65 (+/−1), with a target pH of about 1.65 in an embodiment. In a non-limiting embodiment, sodium bisulfate is solubilized water at a concentration in a range of about 0.25-1%, or about 0.35-0.5%. In embodiments of the invention, the acid concentration is set so that the mixture of oats, water, and acid, at completion of the soak time, reach a pH of about 3-5, about 3-4.5, about 3-4, about 4.4-4.6, or about 4.6, 4.5, 3.9, 3.8, 3.7, 3.6, 3.5, 3.4, 3.3, 3.2, or 3.1. In embodiments, the acid concentration is set so that the mixture of oats, water, and acid, at completion of soak time, reach a pH of about 4.6 or less, 4.5 or less, 3.9 or less, or 3.6 or less. In any embodiment, the concentration of sodium bisulfate used in the mixture acidifies the oats to a final pH of about 4.6 or less.

Referring to FIGS. 1-3, the soaking step 112/114, 210/214, 310/314 involves immersing unsoaked (e.g., pretreated or dry) oats in water mixed with sodium bisulfate (or other disclosed acid) at a predetermined ratio of oats to soaking solution at a target temperature for a duration of time. Pretreated (or dry) oats, which may also be referred to as prehydrated oats, generally have about 10% (+/−5%) water by weight. As used in the application, when referencing a range, the term “about” modifies both ends of the range. For example, the phrase “about 20-250%” means a ranges of “about 20 to about 250”.

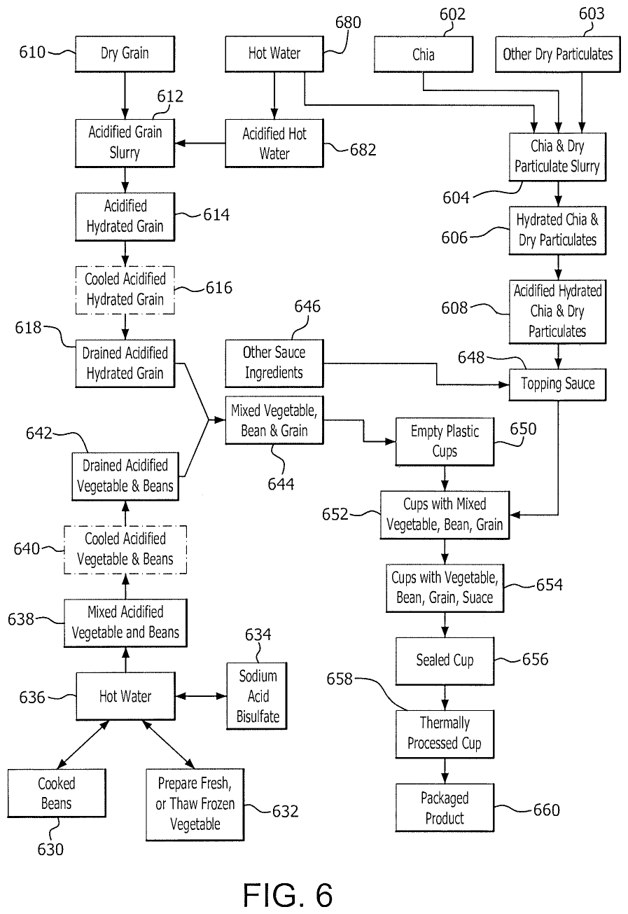

In non-limiting, exemplary embodiments of the invention, the oat-to-soaking solution ratio used in the oat soaking step 112/114, 210/214, 310/314 can range from 1 part oats: 2-12 parts soaking solution, 1 part oats: 4-8 parts soaking solution, or the oat-to-soaking solution ratio can be 1:8, 1:7, 1:6, 1:5, or 1:4. In other embodiments, an alternative high β-glucan cereal grain, i.e., barley (see, e.g., FIG. 6), can be used in place of oats with ratios of barley to soaking solution that are the same as the oat-to-soaking solution ratio, e.g., 1:8, 1:7, 1:6, 1:5, or 1:4, and preferably 1:4.

During the step of soaking oats 112/114, 210/214, 310/314, the mixture of oats and soaking solution can be at a temperature selected for a time sufficient for the physiochemical reaction between the acid in the soaking solution (e.g., sodium bisulfate) and β-glucan (e.g., hydrolysis and solubilization), as well as hydration and acidification of oats. The soak time takes into consideration the indirect relationship between soak temperature and time. For example, the soaking solution can be provided at ambient temperature, but would require a longer soak time in comparison to a heated soaking solution, which would require less soak time. For efficient commercial processing, it is preferred that the soaking solution used for the soak is provided at a temperature in a range from about 120-205 degrees F., or preferably about 185 degrees F. in a specific embodiment. Alternative soaking solution temperatures can be used without limiting the mode of operation of this invention.

The soak time for the oats can range from about 1-30 minutes, about 5-10 minutes, or about 6-7 minutes. This time period can be selected for individual or combined conditions including, but not limited to, the temperature of the soaking solution, the nature or type of the oats or other high β-glucan cereal grain, the target moisture of the oats or other alternative cereal grain, and the nature, type, and concentration of the acid or acids mixed in the soaking solution.

Referring to FIGS. 1-3, the water of the soaking solution used in the soaking step 112/114, 210/214, 310/314 (or elsewhere in embodiments of this invention) can be any type including, but not limited to, tap water, deionized water, distilled water, filtered water, purified water, fortified water, spring water, or the like. In alternative embodiments, a fruit or vegetable juice or juice concentrate, or non-dairy milk, can be mixed with the water in the soaking solution, or used as a standalone liquid for the soaking solution, as long as the liquid would not be modified by exposure to low pH (i.e., about 4.6 or less) that would impart an undesirable texture, color, or flavor to either the liquid or the hydrated oats.

Referring again to FIGS. 1-3, the soaking step 112/114, 210/214, 310/314 targets a hydration percentage of oats (for non-drinkable products) at about 20-250% water by weight of the pretreated oats (i.e., after hydration the oats may be between about 1.1-3.6 times their pretreated weight), or within about 72-75 wt % water by weight of pretreated oats (i.e., after hydration the oats may be between about 1.62-1.85 times their pretreated weight). In alternative embodiments, it is preferred that the hydrated oats have moisture at about 25-75% water by weight of the pretreated oats (i.e., after hydration the oats may be between about 1.15-1.85 times their pretreated weight), about 40-60% water by weight of pretreated oats (i.e., after hydration the oats may be between about 1.3-1.7 times their pretreated weight), about 45%-55% water by weight of pretreated oats (i.e., after hydration the oats may be between about 1.35-1.65 times their pretreated weight), or about 50% water by weight of pretreated oats (i.e., after hydration the oats may be between about 1.4-1.6 times their pretreated weight). Furthermore, if the packaged food product should have a soft texture, such as baby food, the oats can be hydrated from about 76-100% water by weight of pretreated oats (i.e., after hydration the oats may be between about 1.66-2.1 times their pretreated weight), or, for drinkable products, up to about 80-90% or above water by weight of pretreated oats (i.e., after hydration the oats may be more than about 1.7 times their pretreated weight).

In alternative embodiments (see, e.g., FIG. 6), the high β-glucan cereal grain is barley, and the target hydration percentage of barley (for non-drinkable products) is from about 55-75% water by weight of the pretreated barley.

In embodiments show in FIGS. 1-3, the soaking step can be followed by an optional step of adding fresh water 116, 216, 316 at ambient (or cooler) temperature to cool the mixture of water, sodium bisulfate, and hydrated and acidified oats upon completion of the soak time. Then, the hydrated and acidified oats are drained 118, 218, 318 to substantially remove the soaking solution and any water added to cool the mixture. In an optional embodiment, and after being drained, the hydrated and acidified oats can be rinsed with fresh water to wash away any acid and/or β-glucan from the surface of the hydrated and acidified oats.

In an embodiment, a consumable liquid sensitive to low pH levels, e.g., dairy milk, can be added to the hydrated and acidified oats after the rinse step. Other suitable liquids include non-dairy milk, or fruit and/or vegetable juice or juice concentrates.

Referring to FIGS. 1-3, the step of soaking oats 112/114, 210/214, 310/314 in water acidified with sodium bisulfate or other acid solution of this invention can occur in batch or continuous processing, or in partial batch or continuous processing.

B. Soaking Mucilaginous Seeds to Hydrate the Seeds for Use as a Hydrocolloid with High β-Glucan Cereal Grain in Wet Food Systems of the Packaged Food Products

Referring to FIGS. 1-3, embodiments of processes of the invention include the step of separately hydrating mucilaginous seeds 102, 202, 302 (e.g., chia seeds or basil seeds) by soaking the seeds in water (or soaking solution) to create a slurry 104, 204, 304. In embodiments of this step, the mucilaginous seeds can be soaked in water (or soaking solution) at a seed-to-water ratio and at a target temperature for a sufficient time period to hydrate the mucilaginous seeds to at least twice their dry weight, or, alternatively, up to about 95% of the water absorption potential of the seeds. The hydrated mucilaginous seeds provide a hydrocolloid (e.g., a gelatinous matrix) that is later mixed with the acidified and hydrated oats 120, 220, 320 (see, FIGS. 1-3).

In an embodiment, the mucilaginous seeds 102, 202, 302 are chia seeds, or, alternatively, basil seeds, either of which form a hydrocolloid useful for the packaged food systems of this invention. Without being limited to any theory or mode of operation, mucilaginous seeds can be selected for characteristics useful for modifying the rheology of a wet food system, namely, flow behavior, i.e., viscosity, while maintaining the structure and texture of components of the wet food system in the packaged food product. Such characteristics include the ability of the mucilaginous seeds to absorb free water up to at least 10 times the dry weight of the mucilaginous seeds.

Without being limited to any theory or mode of operation, and in the context of this invention, edible biopolymers may be used in place of the mucilaginous seeds as long as the edible biopolymer has about 5-25% dry weight of mucilage or other gelatinous substance that forms a hydrocolloid or phycocolloid, and the mucilage or other gelatinous substance readily absorbs free water up to at least 10 times the dry weight of the edible biopolymer. For example, other edible biopolymers can include powders formed from dried and ground agar-agar (algae), aloe vera, basella alba, basil seed, cactus, chia seed, Dioscorea opposita, fig, flax seed, Irish moss, kelp, licorice root, mullein, oats, okra, plantain, psyllium seed husk, or seaweed.

In non-limiting, exemplary embodiments, the mucilaginous seed-to-water ratio can be 1 part seeds:10 to 50 parts water, 1 part seeds:15 to 40 parts water, or 1 part seed:20 parts water, or the mucilaginous seeds can be soaked in water in a range from about 2.5 to about 7.5% of the slurry 104, 204, 304. In an embodiment, the mucilaginous seed-to-water ratio for hydrating mucilaginous seeds (e.g., chia seeds) to be mixed with hydrated, acidified oats is 1:20. In an alternative embodiment, see, e.g., FIG. 6, the mucilaginous seed-to-water ratio for hydrating mucilaginous seeds (i.e., chia seeds) to be mixed with hydrated and acidified barley can be 1 part seeds:10 to 50 parts water, 1 part seeds:15 to 40 parts water, or 1 part seeds:20 parts water 1:20 to 1:40, and preferably 1:20, 1:30, or 1:40.

In non-limiting, exemplary embodiments, the temperature of the slurry of water and mucilaginous seeds 104, 204, 304 can be maintained in a range of about 80-205 degrees F. In an embodiment, the temperature of the slurry of water and mucilaginous seeds 104, 204, 304 is about 170 degrees F. Other temperatures can be used for the slurry of water and mucilaginous seeds 104, 204, 304 without departing from the mode of operability of this invention, but such temperatures could increase or decrease the soak time for the mucilaginous seeds.

In non-limiting, exemplary embodiments shown in FIGS. 1-3, the duration of the step of soaking mucilaginous seeds 104, 204, 304 can be up to about 20 minutes, about 10 minutes, or less than 10 minutes, as long as the conditions support hydration of the mucilaginous seeds to at least twice the dry weight of the seeds, or, alternatively, up to 95% of the water absorption potential of the seeds. This time period can be selected for individual or combined conditions including, but not limited to, the temperature of the slurry, the nature of the mucilaginous seeds or other edible biopolymer, and the target moisture content of the mucilaginous seeds or other edible biopolymer.

Referring now to FIGS. 1-3, the step of hydrating mucilaginous seeds 104, 204, 304 can include a further step of acidifying the hydrated mucilaginous seeds using sodium bisulfate 108, 208, 308. In embodiments, the sodium bisulfate can be added to the slurry of water and hydrated mucilaginous seeds in an amount suitable to reach a concentration of about 0.1% (+/− about 0.05%) in the slurry. Sodium bisulfate (or other suitable acid workable with this invention) can be added before or during the soaking of the mucilaginous seeds. The mucilaginous seeds can be acidified to a pH that is compatible with, and does not disrupt, the target pH of the separately hydrated and acidified cereal grain, e.g., about 4.6 or less.

Referring again to FIGS. 1-3, the process includes the step of optionally adding other ingredients 250, 350 to the slurry containing hydrated and acidified mucilaginous seeds. These optional ingredients can be selected for flavor in the packaged food product and can include, but are not limited to, sweeteners, ascorbic acid (in a limited amount to preserve color of any fruit that is added to the food product later in the process, but a concentration that does not impart a sour taste), salt, flavor, spice, juice, color, other seeds, nuts, or non-dairy milk.

In non-limiting, exemplary embodiments, the step of hydrating mucilaginous seeds can include the step of adding 252, 352 dry particulates (e.g., pepper, onion, or other dry particulate matter) to the slurry of water and hydrated mucilaginous seeds, either before, during, or after the step of hydrating and acidifying the mucilaginous seeds. In this alternative step, the dry particulate matter can be hydrated and acidified to the target pH of about 4.6 or less, while also imparting flavor to the acidified, hydrated mucilaginous seeds.

Upon completion of the step of soaking mucilaginous seeds to hydrate and acidify the mucilaginous seeds, the excessive soaking solution can be drained from the mucilaginous seeds, in an embodiment.

C. Uniformly Mixing Acidified and Hydrated Mucilaginous Seeds with the Acidified and Hydrated High β-Glucan Cereal Grain

Referring to FIGS. 1-3, embodiments of processes of this invention include the step of uniformly mixing 120, 220, 320 hydrated and acidified high β-glucan cereal grain, e.g., oats, with hydrated and acidified mucilaginous seeds (e.g., chia seeds) or other edible biopolymer, at a target ratio of cereal grain to seeds. In an embodiment, the ratio of hydrated cereal grain to hydrated mucilaginous seeds combined in the slurry can be about 1:1, about 1:2, about 1:3, or about 1:4 or other suitable ratio. The step of mixing 120, 220, 320 can take place for a sufficient period of time to create a uniform mixture. In an embodiment, the time period is about 1 to about 5 minutes at a suitable temperature, which, in embodiments, is in a range of about 100-140 degrees F. In a specific embodiment, the target temperature of the uniform mixture is preferably about 120 degrees F.

The uniform mixture of hydrated and acidified high β-glucan cereal grain, e.g., oats, with the hydrated and acidified mucilaginous seeds (e.g., chia seeds) has a pH of about 4.6 or less.

D. Portioning Uniform Mixture of Acidified and Hydrated Mucilaginous Seeds with the Acidified and Hydrated High β-Glucan Cereal Grain

Referring to FIGS. 1-3, embodiments of the processes of this invention include the step of portioning the uniform mixture of hydrated, acidified high β-glucan cereal grain, e.g., oats, with the hydrated mucilaginous seeds (i.e., chia seeds) into containers 126, 224/226, 324/326 to be sealed and commercially processed.

Referring again to FIGS. 1-3, the step of portioning the uniform mixture into containers 126, 224/226, 324/326 can take place under any of the filling conditions, as follows: (1) the uniform mixture with any previously added ingredients, (2) the uniform mixture with non-citrus fruit or vegetable pieces deposited on top of or mixed within the portion, (3) the uniform mixture deposited on top of any non-citrus fruit or vegetable previously deposited in the container, or (4) depositing one or more layers of non-citrus fruit or vegetables within one or more layers of the uniform mixture. In exemplary, non-limiting embodiments, a topping, syrup, other ingredient(s) (e.g., sweeteners, ascorbic acid, salt, flavor, spice, juice, color, other seeds, nuts, or non-dairy milk), or water can be added to the portion of the uniform mixture, with or without non-citrus fruits and/or vegetables.

In exemplary, non-limiting embodiments, the uniform mixture can be added at about 5-85% by weight, about 10-70% by weight, or 33.5% by weight of the total contents loaded into the container. Conversely, the uniform mixture can be added at about 15-95% by weight, about 30-90% by weight, or about 66.5% by weight of the total contents loaded into a container. In an embodiment, the portion of the uniform mixture, with or without non-citrus fruits and/or vegetables, can be agitated after being loaded into the container.

In the various embodiments of the processes, as well as the packaged food products of this invention, non-citrus fruit and/or vegetables are included. The non-citrus fruit and/or vegetables can be whole, sliced, diced, cubed, comminuted into smaller sizes, or pulverized or pureed in any embodiment. The non-citrus fruit or vegetable can be blanched. These non-citrus fruits are suitable for other embodiments of the packaged food products of this invention.

Referring to FIGS. 1-3, fruit suitable for use as ingredients added during the processing steps 124/126, 224, 324 to obtain the packaged food products of the invention is non-citrus fruit, see, e.g., Examples 1-9. These non-citrus fruits are suitable for other embodiments of this invention.

Vegetables suitable for use as components added during the processing steps to obtain the packaged food products of this invention can include, without limitation, green vegetables, orange vegetables, root vegetables, starchy vegetables, and other vegetables. The vegetables will be previously harvested, cleaned, and prepared, and can be fresh, drained, canned, or thawed (frozen). Green vegetables for use in the process include, without limitation, asparagus, broccoli, cucumbers, celery, grape tomatoes, green beans, green peppers, onions, peas, snap peas, snow peas, zucchini, and the like. Other vegetables include carrot, corn, green beans, or sweet potato. In further embodiments, whole, sliced, diced, cubed, comminuted, pulverized or pureed mushrooms, such as, for example, Button, Cremini, Portobello, Porcini, Shiitake, and the like, could be added to the hydrated and acidified high β-glucan cereal grain (with or without mucilaginous seed) in a preferred embodiment, in connection with the same modes of operability of this invention. These vegetables are suitable for other embodiments of the packaged food products of this invention.

In embodiments of the invention, the packaged food product can include a single type of non-citrus fruit, a plurality of types of non-citrus fruits, a single type of vegetable, a plurality of types of vegetables, or any combination thereof, in the uniform mixture containing hydrated and acidified high β-glucan cereal grains, and/or hydrated and acidified mucilaginous seed. Alternatively, the packaged food product can include a combination of vegetable and non-citrus fruit at a ratio of fruit to vegetable of 1:1, 1:2, 1:3, or 1:4.

E. Sealing Portioned, Uniformed Mixture of Acidified and Hydrated Mucilaginous Seeds with the Acidified and Hydrated High B-Glucan Cereal Grain into Containers for Commercial Processing

Referring to FIGS. 1-3, embodiments of the processes of this invention include the step of sealing 128, 228, 328 each container loaded with portions of the uniform mixture, with or without non-citrus fruit, vegetables, or other added ingredient(s), using a lid and/or film to seal the packaged food product in the container(s). For example, container openings can be hermetically sealed with or without a film—depending on the nature of the container—using commonly known commercial techniques.

F. Commercial Processing of the Packaged Food Products

Referring generally to FIGS. 1-3, embodiments of processes of this invention include the further step of commercially processing the packaged food products 130, 230, 330 within the commercial standards and requirements of the food industry (as regulated by food regulatory authorities) for controlling foodborne pathogens. According to the embodiments of this invention, commercial processing can be adapted with heating times and temperatures, or, alternatively, pressure or other treatment, optimized in a manner to minimize exposure of the contents of the packaged food products to excessive heat and/or pressure conditions. Sealed containers can be heated to commercially sterilize their contents. Commercial sterilization can occur in a hot water bath at atmospheric pressure, using a retort to heat at a higher temperature, or any other commercial means suitable for heating the contents of the container.

FIG. 1 illustrates that the step of commercial processing involves thermal processing 130 of the packaged food product, with or without non-citrus fruits or vegetables, under conditions used to create a packaged food product that is shelf stable. For example, the thermal processing 130 can be a mild heat treatment, e.g., F_{16/200}≥0.1, that preserves the flavor, texture, structure, and visual appearance of the components of the packaged food product.

FIGS. 2-3 illustrate the step of commercial processing of the packaged food product under conditions used to create a packaged food product that is ready-to-eat and requires refrigeration 232. In the embodiment illustrated in FIG. 2, the step of commercial processing can be high pressure processing (HPP) 230. In a non-limiting, exemplary embodiment, the sealed container can undergo HPP at about 400-600 mPa for about 1-5 minutes. In the embodiment illustrated in FIG. 3, the step of commercial processing can be thermal processing of the packaged food product 330 under conditions that are used to create a ready-to-eat food product that also requires refrigeration 332. In an embodiment, thermal processing can be F_{18/200}>0.1, or F_{16/160}=1 for minimal thermal processing (pasteurization).

The non-limiting, exemplary embodiments of the foregoing processes of this invention illustrated in FIGS. 1-3 can take place in a large scale, batch or continuous, commercial operation, whereby each step may be automated with commercial machinery, carried out manually, or some combination of both.

G. Alternative Process Using Sodium Bisulfate as Soaking Solution in Manufacturing Packaged Food Products with Hydrated and Acidified High β-Glucan Cereal Grain, with or without Non-Citrus Fruit and/or Vegetables

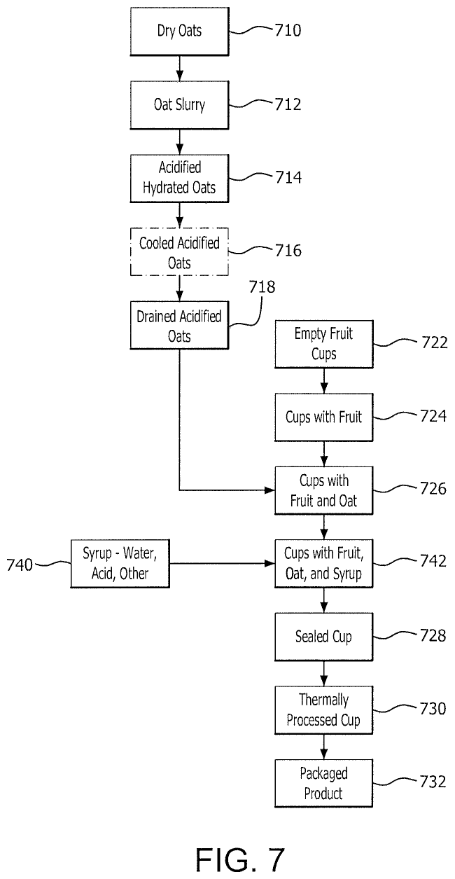

Referring now specifically to FIG. 7, an alternative embodiment of the processes of this invention is provided and modifies certain steps of the processes disclosed above in II A-F and shown in FIGS. 1-3. Generally, the sole modification of this alternative embodiment is to not add mucilaginous seeds, while manufacturing a packaged food product having hydrated and acidified high β-glucan cereal grain (e.g., oats or barley) portioned with or without non-citrus fruit and/or vegetable.

Referring to FIG. 7, the modified process generally includes:
(1) the step of soaking 712 high β-glucan cereal grain (e.g., oats or barley) in water acidified with sodium bisulfate to hydrate the cereal grain and to acidify the cereal grain 714 to a pH of about 4.6 or less before, optionally, cooling 716 the hydrated and acidified oats and then substantially draining 718 the excess soaking solution from the cereal grain;
(2) the modified step of portioning 726 hydrated and acidified high β-glucan cereal grain, i.e., oats, (without added mucilaginous seeds) into containers 722, with or without non-citrus fruit 724, to be sealed and commercially processed;
(3) the step of adding syrup 740 which may contain water and an acid disclosed with this invention, or other components to the container 742;
(4) the step of sealing 728 each container loaded with a portion of the hydrated and acidified high β-glucan cereal grains, e.g., oats, with or without non-citrus fruit, vegetables, or other added ingredient, with a lid and/or film to form the packaged food product; and
(5) the step of commercially processing 730 the packaged food product within the general commercial standards and requirements of the food industry (as regulated by food regulatory authorities) for controlling foodborne pathogens in the packaged food product 732.

This modification illustrated in FIG. 7 can encompasses any one or more of the various and alternative embodiments disclosed above in II A-F and shown in FIGS. 1-3, with the exception of hydrating and acidifying mucilaginous seeds and incorporating the hydrated and acidified mucilaginous seeds in the process and in the packaged food product 732.

H. Another Alternative Process Using Sodium Bisulfate as Soaking Solution in Manufacturing Packaged Food Products with Hydrated and Acidified High β-Glucan Cereal Grain with Vegetables

Referring now specifically to FIG. 6, an alternative embodiment of the process of this invention is provided that modifies the steps of the process disclosed above in II A-F and shown in FIGS. 1-3.

Generally, this embodiment illustrated in FIG. 6 modifies the steps of the process disclosed in II A-F by including steps for:
(i) acidifying vegetable 638 (e.g., corn, carrot, sweet potato, green bean, or peas) to a pH of 4.6 or less;
(ii) uniformly mixing the acidified vegetable with barley 644 at a vegetable-to-barley ratio of 1:1 up to 1:8 or higher that has been hydrated and acidified according to the process for barley (see, II A, above);
(iii) portioning the uniformly mixed vegetables and barley into containers 650;
(iv) creating a topping syrup 608 comprising mucilaginous seeds (e.g., chia seeds) hydrated and acidified according to this invention for use with barley (see, II B, above) that may include dry particulates and other topping sauce ingredients (e.g., salt, flavors, spices, juices, sweeteners, vinegars, purees, color, oil, non-dairy milk, or ascorbic acid, or any combination thereof);
(v) topping 652 the portions of the uniformly mixed vegetables and barley into the containers with the mucilaginous seed-based topping sauce and optionally heating the containers below a temperature typically used for controlling foodborne pathogens; and then
(vi) sealing 656 and commercially processing 658 the containers within the general commercial standards and requirements of the food industry (as regulated by food regulatory authorities) for controlling foodborne pathogens.

In this embodiment shown in FIG. 6, the contents of the components of the packaged food product 660 reach a pH of about 4.6 or less within about 24 hours or less after commercial processing. This modified process shown in FIG. 6 can encompass the various and alternative embodiments disclosed in II A-F (above).

Referring again to FIG. 6, the process of this embodiment includes the step of forming 636 a mixture of: (i) cooked beans 630 and/or fresh, drained, canned, cooked or thawed (previously frozen) vegetables 632 (e.g., corn, carrot, sweet potato, green bean, peas) with (ii) a soaking solution, e.g., water acidified with an acid 634 operable with this invention, for example, sodium bisulfate. The soaking solution can be provided at a temperature in a range from about 80-205 degrees F., 175-195 degrees F., or preferably about 185 degrees F. The soaking solution 636 can be acidified to a pre-immersion pH in a range of about 1.55-1.65 (+/−1), with a pH of about 1.65 in an embodiment. In a non-limiting embodiment of the soaking solution, sodium bisulfate is solubilized in water at a concentration in a range of about 0.25-1.5%, or about 0.35-1%. The mixture 636 is mixed 638 and held for a time period in a range of about 1-30 minutes, about 5-30 minutes, about 10-25 minutes, about 10-20 minutes, about 6-7 minutes, or about 15 minutes to acidify the beans and/or vegetables within the target pH by exposure to the acid or acid solution 638 of the invention.

In an optional embodiment, fresh water can be added 640 at ambient (or cooler) temperature to cool the mixture 638 of beans and/or vegetables upon completion of the soak time before excess soaking solution is drained from the mixture. Referring to FIG. 6, the beans 630 and/or vegetables 632 are substantially drained 642 to remove the soaking solution, e.g., acidified water, and any water added to cool the mixture. In an optional embodiment, and after being substantially drained 642, the beans 630 and/or vegetables 632 can be rinsed with fresh water to wash away any acid.

Referring to FIG. 6, the process includes the step of separately immersing a high β-glucan cereal grain 610, i.e., barley, in water 612 at a ratio of grain to soaking solution (i.e., acidified water) of 1:4 or other disclosed ratio used for hydrating and acidifying oats, for a time period in a range of about 1-30 minutes, about 5-10 minutes, or about 6-7 minutes, to hydrate (e.g., to a target of about 55-75% moisture) and to acidify the cereal grain 614 at a pH of about 4.6 or less. In an optional embodiment, fresh water can be added 616 at ambient (or cooler) temperature to cool the high β-glucan cereal grains upon completion of the soak time. In all embodiments, the high β-glucan cereal grains are drained 618 to remove excess soaking solution and the fresh water (if added to cool the mixture). In an optional embodiment, and after draining excess soaking solution 618, the high β-glucan cereal grain can be rinsed with fresh water to wash away residual acid.

Referring to FIG. 6, the process includes the further step of uniformly mixing 644 the drained beans and/or vegetables 642 with hydrated, acidified high β-glucan cereal grain 618, e.g., barley, at a target ratio of beans and/or vegetables to cereal grain. In embodiments, the drained beans and/or vegetables 642 with hydrated, acidified high β-glucan cereal grain 618 uniformly mixed is provided at a bean-to-vegetable-to-grain ratio of 1:1:1, 3:1:1, 3:2:1, or other suitable bean-to-vegetable-to-grain ratio. The step of mixing 644 occurs for a sufficient period of time to create a uniform mixture. In an embodiment, the uniform mixture is heated to a temperature in a range of 100-140 degrees F. In a specific embodiment, the target temperature of the uniform mixture 644 is preferably about 120 degrees F.

Referring to FIG. 6, the process includes the step of portioning 650 the uniform mixture of substantially drained and acidified beans and/or vegetables with hydrated and acidified barley into containers 650.

Referring to FIG. 6, the process includes the step of topping 652 the uniform mixture with a topping sauce 648. The topping sauce 648 can be provided at a pH of about 4.6 or less, 3-4.5, 3.9, or 3.5. In an embodiment, the topping sauce 648 comprises mucilaginous seeds (e.g., chia seeds) 602 that has been hydrated 604 in the slurry of water to chia seeds (e.g., about 1:30 or other disclosed ratio for chia seeds) and acidified to a pH of 4.6 or less 604 according to the process of this invention as used with barley (see, II B). In embodiments of this invention, the topping sauce 648 can have mucilaginous seeds at about 1-3% by weight, or preferably 2%. In embodiments, the step of topping 652 the uniform mixture with a topping sauce 648 can include adding dry particulates and/or other topping sauce ingredients 646 (e.g., salt, flavors, spices, juices, sweeteners, vinegars, purees, color, oil, non-dairy milk, or ascorbic acid, or any combination thereof) at either the beginning and/or end of the processing used to hydrate mucilaginous seeds.

In exemplary, non-limiting embodiments, the uniform mixture can be portioned at about 5-90% by weight, about 10-70% by weight, 50% by weight, or 33.5% by weight of the total contents loaded into the container with the balance of the weight percentage of the packaged food product comprising the topping sauce 648. In an embodiment, the portion of the uniform mixture can be agitated after being loaded into the container 652 with the topping sauce 648.

Referring to FIG. 6, the containers 654 are then sealed 656 and commercially processed 658 according to this invention to form the packaged food product 660. In an embodiment, commercial processing 658 involves thermal processing at F_{16/200}≥0.1 (i.e., 181° F. for 42 minutes).

III. Packaged Food Products Comprising High β-Glucan Cereal Grain with or without Mucilaginous Seeds

In a non-limiting, exemplary embodiment of this invention, a packaged food product is provided and comprises hydrated oats acidified to a pH of 4.6 or less with sodium bisulfate, according to an embodiment of the processes of this invention (see, II, G). Formulations of this packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, formulations of the packaged food product can be within the applicable range or the preferred range as follows in Example 1.

EXAMPLE 1: Packaged Food Product With Oat

| | | |
|---|---|---|
| characteristic | Applicable Range | Preferred Range |

| | | |
|---|---|---|
| pH | 4.6 or less | 3.9 to 3.5 |

| | | | | |
|---|---|---|---|---|
| Oat (dry) | 3.00%-46.00 | wt % | 20.00-34.00 | wt % |
| Sodium bisulfate | 0.01%-1.50 | wt % | 0.11%-0.35 | wt % |
| Other components | 52.5-96.99 | wt % | 65.65-79.89 | wt % |
| TOTAL | 100 | wt % | 100 | wt % |

In another non-limiting, exemplary embodiment of this invention, a packaged food product is provided and comprises hydrated oats and chia seeds acidified to a pH of 3.9 or less with sodium bisulfate, according to the processes of this invention (see, II, A-F). In this embodiment, formulations of the packaged food product can be within the preferred range as follows in Example 2.

EXAMPLE 2: Packaged Food Product With Oat & Chia

| Characteristic | | Preferred Range | |
|---|---|---|---|
| pH | | 3.9 or less | |
| Oats | Dry weight | 13.5-19.5 | wt % |
| | Hydrated | 27-39 | wt % |
| Sodium bisulfate | | 0.15-0.45 | wt % |
| Chia | Dry weight | 0.75-4.5 | wt % |
| | Hydrated | 10-60 | wt % |

| | | |
|---|---|---|
| TOTAL | 100 | wt % |

In another non-limiting, exemplary embodiment of this invention, a packaged food product is provided and comprises hydrated oats and chia seeds acidified (to a pH of 3.9 or less) with sodium bisulfate, according to the processes of this invention (see, II, A-F) and includes non-dairy milk. In this embodiment, formulations of the packaged food product can be within the preferred range as follows in Example 3.

EXAMPLE 3: Packaged Food Product
With Oat, Chia & Non-Dairy Milk

| Characteristic | | Preferred Range | |
|---|---|---|---|
| pH | | 3.9 or less | |
| Oats | Dry weight | 13.5-19 | wt % |
| | Hydrated | 27-39 | wt % |
| Sodium bisulfate | | 0.1-0.3 | wt % |
| Chia | Dry weight | 0.75-4.5 | wt % |
| | Hydrated | 10-60 | wt % |

| | | |
|---|---|---|
| Non-Dairy Milk | 76-85 | wt % |
| TOTAL | 100 | wt % |

In another non-limiting, exemplary embodiment of this invention, a packaged food product is provided and comprises hydrated oats and chia seeds acidified (to a pH of 3.9 or less) with sodium bisulfate, according to the processes of this invention (see, II, A-F) and includes juice, juice concentrate, and water. In this embodiment, formulations of the packaged food product can be within the preferred range as follows in Example 4.

EXAMPLE 4: Packaged Food Product With Oat & Juice

| Characteristic | | Preferred Range | |
|---|---|---|---|
| pH | | 3.9 or less | |
| Oats | Dry weight | 13.5-19 | wt % |
| | Hydrated | 27-39 | wt % |
| Sodium bisulfate | | 0.1-0.3 | wt % |
| Chia | Dry weight | 0.75-4.5 | wt % |
| | Hydrated | 10-60 | wt % |

| | | |
|---|---|---|
| Juice; Juice Concentrate & | 76-85 | wt % |
| Water | | |
| TOTAL | 100 | wt % |

In another non-limiting, exemplary embodiment of this invention, a packaged food product is provided and comprises non-citrus fruit combined with hydrated oats and chia seeds acidified (to a pH of 3.9 or less) with sodium bisulfate, according to the processes of this invention (see, II, A-F). The packaged food product can also include other components (e.g., any one or combination of water, fruit juice or juice concentrate (e.g., white grape juice), ascorbic acid, sugar, sweetener(s), salt, flavor(s), spice(s), other juice(s), color(s), seeds, nuts, and/or non-dairy or dairy milk. The range of sodium bisulfate can be adjusted depending on the non-citrus fruit type, oats, and how easy or difficult it is to acidify the non-citrus fruit and the oats. In these embodiments, formulations of the packaged food product can be within the applicable range and the preferred range as follows in Examples 5-8.

EXAMPLE 5: General Composition of Packaged
Food Product With Oat, Chia & Fruit

| | | |
|---|---|---|
| Characteristic | Applicable Range | Preferred Range |

| | | |
|---|---|---|
| pH | 3.9 or less | 3.9 or less |

| | | | | |
|---|---|---|---|---|
| Non-citrus Fruit | 1.00-60.00 | wt % | 23.00-39.00 | wt % |
| Oat | 2.00%-40.00 | wt % | 4.00-15.00 | wt % |
| Chia | 0.10%-10.00 | wt % | 0.60-3.00 | wt % |
| Sodium bisulfate | 0.01%-1.50 | wt % | 0.10-0.26 | wt % |
| Other components | 0-60 | wt % | 0-60 | wt % |
| TOTAL | 100 | wt % | 100 | wt % |

In another non-limiting, exemplary embodiment of this invention, a packaged food product comprising non-citrus fruit combined with hydrated oats and chia seeds acidified (to a pH of 3.9 or less) with sodium bisulfate can be formulated within the preferred range as follows in Example 6.

EXAMPLE 6: Packaged Food Product With Oat & Fruit

| | Characteristic | | Preferred Range | |
|---|---|---|---|---|
| pH | | | 3.9 or less | |
| Non-citrus Fruit | | | 10-70 | wt % |
| | Oats | Dry weight | 9-13 | wt % |
| | | Hydrated | 18-26 | wt % |
| Sodium bisulfate | | | 0.1-0.3 | wt % |
| | Chia | Dry weight | 0.5-3 | wt % |
| | | Hydrated | 7.5-45 | wt % |

| | | |
|---|---|---|
| Other components | 0-60 | wt % |
| TOTAL | 100 | wt % |

In another non-limiting, exemplary embodiment of this invention, a packaged food product comprising apple combined with hydrated oats and chia seeds acidified (to a pH of 3.5 or less) with sodium bisulfate and other components can be formulated within the preferred range as follows in Example 7.

EXAMPLE 7: Packaged Food Product With Fruit & Oats

| Characteristic | Preferred Range | |
|---|---|---|
| pH | 3.5 or less | |
| Apple | 25-35 | wt % |
| Oat | 5-15 | wt % |
| Chia | 1-3 | wt % |
| Sodium bisulfate | 0.1-0.5 | wt % |
| Other components | 50-55 | wt % |
| TOTAL | 100 | wt % |

In another non-limiting, exemplary embodiment of this invention, a packaged food product comprising apple combined with hydrated oats and chia seeds acidified (to a pH of 3.5 or less) with sodium bisulfate, almond butter, whey protein, and other components can be formulated within the preferred range as follows in Example 8.

EXAMPLE 8: Packaged Food Product With Fruit, Oats & Protein

| Characteristic | Preferred Range | |
|---|---|---|
| pH | 3.5 or less | |
| Apple | 20-24 | wt % |
| Oat (drained) | 6-10 | wt % |
| Chia | 0.5-2 | wt % |
| Sodium bisulfate | 0.1-0.2 | wt % |
| Almond Butter | 1-5 | wt % |
| Whey Protein | 1-5 | wt % |
| Other components | 60-65 | wt % |
| TOTAL | 100 | wt % |

In another non-limiting, exemplary embodiment of this invention, a packaged food product is provided and can comprise vegetable combined with hydrated and acidified high β-glucan cereal grain (i.e., barley) combined with sodium bisulfate and, optionally, with hydrated and acidified mucilaginous seeds, according to the processes of this invention (see, II, H). The packaged food product can comprise a vegetable (e.g., carrots, peas, potatoes, garbanzo beans, or combination thereof) in a range of about 20-60 wt % (with a target of about 40 wt %+/−5 wt %), barley in a range of about 1-15 wt % (with a target of about 6 wt %+/− about 2 wt %), and sodium bisulfate in a range of about 0.1-2 wt % (with a target of about 0.7 wt %+/− about 0.2 wt %). Optionally, the packaged food product can also include mucilaginous seeds in a range of about 0.1-8 wt % (with a target of about 1 wt %+/− about 0.3 wt %) and other components (e.g., one or any combination of salt, flavors, spices, juices, sweeteners, vinegars, purees, color, oil, non-dairy milk, or ascorbic acid, or any combination thereof). The packaged food product can have a pH in a range of about 2-4.6, and a pH of about 3.5 in a specific embodiment.

In another non-limiting, exemplary embodiment of this invention, a packaged food product is provided and can comprise acidified high β-glucan cereal grain (i.e., barley) combined with sodium bisulfate, according to the processes of this invention (see, II, H) with the exception of an added vegetable (which can be added as an optional ingredient). The packaged food product can also include other components (e.g., one or any combination of salt, flavors, spices, juices, sweeteners, vinegars, purees, color, oil, non-dairy milk, or ascorbic acid, or any combination thereof). The packaged food product can be formulated within the preferred range as follows in Example 9.

EXAMPLE 9: Packaged Food Product With Barley

| | | |
|---|---|---|
| Characteristic | Applicable Range | Preferred Range |

| | | |
|---|---|---|
| pH | about 2-4.6 | about 3.2-3.8 |

| | | | | |
|---|---|---|---|---|
| Barley (drained) | 3-46 | wt % | 26-40 | wt % |
| Sodium bisulfate | 0.01-1.5 | wt % | 0.11-0.35 | wt % |
| Other components | 52.5-96.99 | wt % | 59.65-73.89 | wt % |
| TOTAL | 100 | wt % | 100 | wt % |

Manufactured according to the embodiments of the processes of this invention (see, II, A-H), the packaged food products are ready-to-eat and can be a shelf stable, non-refrigerated food product (i.e., once opened needs to be refrigerated if not fully consumed) or, alternatively, a refrigerated food product. The packaged food product can also be blended with a food produced by bacterial fermentation of dairy milk (e.g., yogurt, kefir). The packaged food product can be formulated to be drinkable, such as, a smoothie or other blended drink product that includes dairy milk, non-dairy milk, or juice.

IV. Processes Using Sodium Bisulfate as an Additive Used in Manufacturing Packaged Food Products Having Vegetable with or without Non-Citrus Fruit

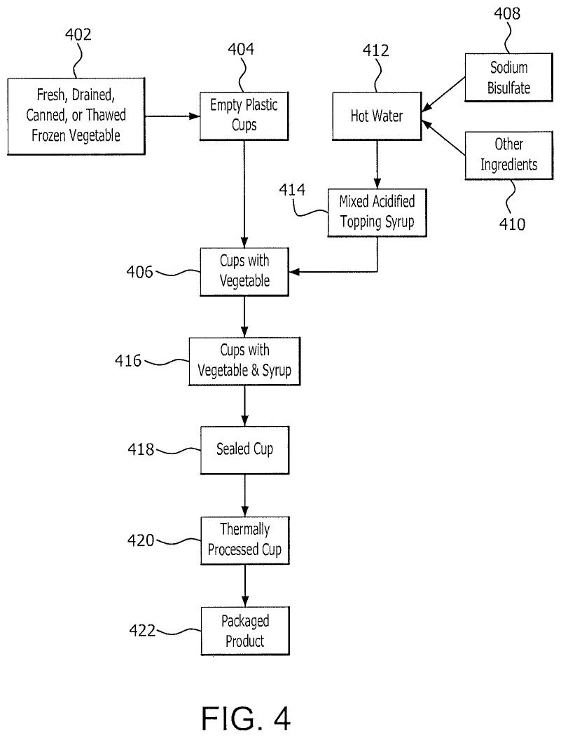

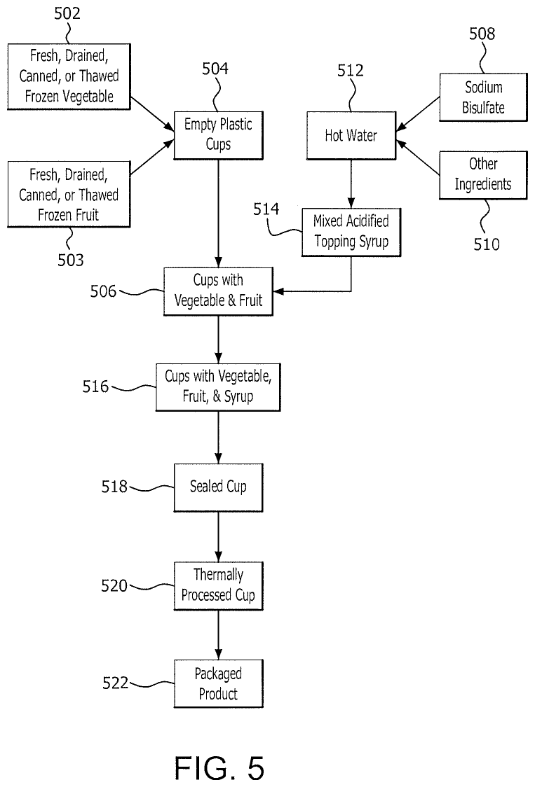

Referring generally to FIGS. 4 and 5, embodiments of processes of this invention provide for mixing in a container 406, 506 (i) vegetables, or (ii) predominantly vegetables with non-citrus fruit (e.g., at a ratio of 1:1, 1:2, 1:3, 1:4 or other ratio), with an acidified topping solution so that the mixture reaches a pH of about 4.6 or less within 24 hours or less after the container is sealed 418, 518 and commercially processed 420, 520. In these embodiments of this invention, the processes are used to provide novel formulations of packaged food products 422, 522 that have preserved flavor, color, texture, structure, and visual appearance.

A. Acidified Topping Solution

Referring to FIGS. 4 and 5, embodiments of the process include the step of creating an acidified topping solution by mixing 414, 514 (i) hot water 412, 512 at a temperature in a range from about 80-205 degrees F., about 60-100 degrees F., or preferably about 185 degrees F. or about 140 degrees. F, (ii) an acid or acid solution 408, 508, and, optionally, (iii) other components 410, 510 (e.g., juice, sweeteners, sugar, salt, flavor, spice, color, ascorbic acid, hydrated mucilaginous seed, etc.).

The acid or acid solution is selected from those disclosed in this application and is used at a concentration that provides the topping solution 414, 514 with a pre-topping pH in a range of about 1.55 to about 1.65 (+/−1), with a target pH of about 1.65 in an embodiment. In a non-limiting embodiment, the acid is sodium bisulfate. Sodium bisulfate can be solubilized in the hot water 412 at a concentration in a range of about 0.25 to about 1%, or about 0.35 to about 0.5%. In an embodiment, the topping solution has sodium bisulfate at about 0.15-2% by weight or about 0.35-1.3% by weight. The acid concentration is selected so that the pH of the packaged food product 422, 522 reaches a pH of about 3-5, about 4.4-4.6, about 4.5, or about 4.6 or less, within about 24 hours or less after commercial processing.

B. Add Vegetable, or Predominantly Vegetable and Non-Citrus Fruit to Container

Referring to FIGS. 4 and 5, the process includes the step of adding vegetables 404 (e.g., fresh, drained, canned, or thawed (previously frozen)) (see FIG. 4) or predominantly vegetables and non-citrus fruit 504 (e.g., fresh, drained, canned, or thawed (previously frozen)) (see FIG. 5). In an embodiment, the vegetable and non-citrus fruit are added 506 to the container at a ratio of 1:1, 1:2, 1:3, 1:4, or other ratio. In non-limiting, exemplary embodiments, the vegetables can be selected from carrot, corn, green beans, peas, or sweet potato while the non-citrus fruit can be selected from apple, mango, peach, pear, or pineapple.

Examples 10-20 provide non-limiting, exemplary embodiments of formulations of packaged food products comprising vegetable, or predominantly vegetable and non-citrus fruit.

C. Add Acidified Topping Solution to Vegetable or Predominantly Vegetable and Non-Citrus Fruit Previously Loaded into Containers

Referring to FIGS. 4 and 5, the process includes the step of adding acidified topping solution 406, 506 to the container to immerse 416, 516 the (i) vegetables (see FIG. 4), or (ii) vegetables and non-citrus fruit (see FIG. 5). In embodiments, the acidified topping solution 406, 506 can be added 406, 506 to the container at ambient temperature, or, optionally, heated to a temperature in a range from about 80-205 degrees F., or preferably about 185 degrees F., prior to being added to the container and its contents.

D. Sealing Mixture of Acidified Topping Solution and Vegetable, or Predominantly Vegetable and Non-Citrus Fruit, Loaded into Containers and Commercially Processing the Packaged Food Product

Referring to FIGS. 4 and 5, the process includes the next step of sealing 418, 518 (in the same manner as described in II, E) each container closed by a film and/or lid after the container has been loaded with a suitable portion of: (i) vegetables, or (ii) vegetables and non-citrus fruit to the packaged food product 422, 522.

Referring again to FIGS. 4 and 5, the process of an embodiment of this invention includes the further step of commercially processing 420, 520 the packaged food product within the general commercial standards and requirements of the food industry (as regulated by food regulatory authorities) for controlling foodborne pathogens. Commercial processing 420, 520 can be optimized with heating times and temperature, or, optionally, pressure, to minimize exposure of the components of the sealed container to excessive heat or pressure.

FIGS. 4 and 5 illustrate that the step of commercial processing 420, 520 can involve thermal processing of the packaged food product under conditions that are used to reach a shelf stable product. Thermal processing can be a mild heat treatment, e.g., F_{16/200}≥20 (222 degrees F. for 11 minutes) to preserve the integrity and texture of the contents of the packaged food product 422, 522. Alternatively, the step of commercial processing 420, 520 can involve processing the contents of the sealed container under conditions that are used to create a packaged food product that requires refrigeration, e.g., high pressure processing (HPP). In a non-limiting, exemplary embodiment, the sealed container can undergo HPP at about 400-600 mPa for about 1-5 minutes. In an alternative embodiment, the step of commercial processing 420, 520 can be minimal thermal processing (pasteurization) of the sealed container under conditions that are used to reach a packaged food product that must be refrigerated.

The non-limiting, exemplary embodiments of the foregoing processes of this invention illustrated in FIGS. 4 and 5 can take place in a large scale, batch, or continuous commercial operation, whereby each step can be automated with commercial machinery, carried out manually, or some combination of both.

V. Packaged Food Products Having Vegetables, or Predominantly Vegetables with Non-Citrus Fruit Having Sodium Bisulfate as an Additive

Referring again to FIGS. 4 and 5, this invention provides packaged food products 422, 522 with a vegetable, or predominantly vegetable and non-citrus fruit, mixed with sodium bisulfate, as an additive. The packaged food product can also include other components (e.g., water, fruit juice concentrate, such as white grape juice, ascorbic acid, sugar, sweetener(s), salt, flavor(s), spice(s), other juice(s), color(s), other seeds, nuts, and/or non-dairy or dairy milk), alone or in combination. Preferred vegetables from a consumer preference can be carrots, corn, green beans, peas, or sweet potato. The range of sodium bisulfate can be adjusted depending on the type of vegetable and/or non-citrus fruit, as well as how easy or difficult it is to acidify the vegetable and/or non-citrus fruit with the sodium bisulfate (or other acid disclosed and operable with this invention) so the packaged food product reaches a pH of 4.6 or less within about 24 hours or less after commercial processing.

A. Vegetable-Based Packaged Food Products

In a non-limiting, exemplary embodiment of this invention, a packaged food product is provided and comprises corn acidified by sodium bisulfate to a pH of 4.6 or less, according to the embodiment of the processes of this invention (see, IV, A-D). The formulation of this packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 10.

EXAMPLE 10: Packaged Food Product With Corn

| | | |
|---|---|---|
| | Applicable | Preferred |
| Characteristic | Range | Range |

| | | | | |
|---|---|---|---|---|
| pH | 2.5-4.6 | wt % | 3.8-4.4 | wt % |
| Corn | 35-75 | wt % | 50-60 | wt % |
| Sodium bisulfate | 0.5-2.0 | wt % | 0.6-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises carrot acidified by sodium bisulfate to a pH of 4.6 or less, according to the embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 11.

EXAMPLE 11: Packaged Food Product With Carrot

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Carrot | 35-75 | wt % | 50-60 | wt % |
| Sodium bisulfate | 0.1-1.5 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other | 0-35 | wt % | 0-35 | wt % |
| components | | | | |
| TOTAL | 100.00 | wt % | 100.00 | wt % |

In a non-limiting, exemplary embodiment of this invention, a packaged food product is provided and comprises sweet potato acidified by sodium bisulfate to a pH of 4.6 or less, according to the embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 12.

EXAMPLE 12: Packaged Food Product With Sweet Potato

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Sweet Potato | 35-75 | wt % | 50-60 | wt % |
| Sodium bisulfate | 0.1-1.5 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises green beans acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 13.

EXAMPLE 13: Packaged Food Product With Green Beans

| | | |
|---|---|---|
| | Applicable | Preferred |
| Characteristic | Range | Range |

| | | |
|---|---|---|
| pH | 2.5-4.6 | 3.8-4.4 |

| | | | | |
|---|---|---|---|---|
| Green Beans | 35-75 | wt % | 50-60 | wt % |
| Sodium bisulfate | 0.3-1.4 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

B. Vegetable and Non-Citrus Fruit-Based Packaged Food Products

In non-limiting, exemplary embodiments of this invention, a packaged food product is provided and comprises corn and peaches acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 14.

EXAMPLE 14: Packaged Food Product With Corn and Peach

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Corn | 25-75 | wt % | 30-45 | wt % |
| Peaches | 1-30 | wt % | 10-20 | wt % |
| Sodium bisulfate | 0.1-2 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises carrot and pear acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 15.

EXAMPLE 15: Packaged Food Product With Carrot and Pear

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Carrots | 25-75 | wt % | 30-45 | wt % |
| Pear | 1-30 | wt % | 10-20 | wt % |
| Sodium bisulfate | 0.05-1.5 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises sweet potato and apple acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range and the preferred range as follows in Example 16.

EXAMPLE 16: Packaged Food Product
With Sweet Potato and Apple

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Sweet Potato | 25-75 | wt % | 30-45 | wt % |
| Apple | 1-30 | wt % | 10-20 | wt % |
| Sodium bisulfate | 0.05-1.5 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises green bean and pineapple acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 17.

EXAMPLE 17: Packaged Food Product
With Green Bean and Pineapple

| | | |
|---|---|---|
| | Applicable | Preferred |
| Characteristic | Range | Range |

| | | |
|---|---|---|
| pH | 2.5-4.6 | 3.8-4.4 |

| | | | | |
|---|---|---|---|---|
| Green Bean | 25-75 | wt % | 30-45 | wt % |
| Pineapple | 1-30 | wt % | 10-20 | wt % |
| Sodium bisulfate | 0.07-1.7 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises corn and mango acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy milk or dairy milk. In this embodiment, the packaged food product can be formulated within the applicable range or the preferred range as follows in Example 18.

EXAMPLE 18: Packaged Food Product With Corn and Mango

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Corn | 25-75 | wt % | 30-45 | wt % |
| Mango | 1-30 | wt % | 10-20 | wt % |
| Sodium bisulfate | 0.1-2 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises carrot and pineapple acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy or dairy milk. In this embodiment, the packaged food product can be formulated within the applicable range or the preferred range as follows in Example 19.

EXAMPLE 19: Packaged Food Product With Carrot and Pineapple

| | | |
|---|---|---|
| | Applicable | Preferred |
| Characteristic | Range | Range |

| | | |
|---|---|---|
| pH | 2.5-4.6 | 3.8-4.4 |

| | | | | |
|---|---|---|---|---|
| Carrot | 25-75 | wt % | 30-45 | wt % |
| Pineapple | 1-30 | wt % | 10-20 | wt % |
| Sodium bisulfate | 0.05-1.5 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

In a non-limiting, exemplary embodiment of this invention, a packaged food product is provided and comprises peas and apple acidified by sodium bisulfate to a pH of 4.6 or less, according to an embodiment of the processes of this invention (see, IV, A-D). The formulation of the packaged food product can include other components such as, for example, any one or combination of water, fruit juice or juice concentrate (e.g., white grape juice), ascorbic acid, sugar, sweetener(s), salt, flavor(s), spice(s), other juice(s), color(s), other seeds, nuts, and/or non-dairy milk or dairy milk. In this embodiment, the packaged food product can be formulated within the applicable range or the preferred range as follows in Example 20.

EXAMPLE 20: Packaged Food Product With Peas and Apple

| | | |
|---|---|---|
| | Applicable | Preferred |
| Characteristic | Range | Range |

| | | |
|---|---|---|
| pH | 2.5-4.6 | 4-4.5 |

| | | | | |
|---|---|---|---|---|
| Peas | 25-75 | wt % | 30-45 | wt % |
| Apple | 1-30 | wt % | 10-20 | wt % |
| Sodium bisulfate | 0.1-2 | wt % | 0.1-1.0 | wt % |
| White grape juice | 0-20 | wt % | 8-14 | wt % |
| conc. | | | | |
| Ascorbic acid | 0-1 | wt % | 0-0.4 | wt % |
| Other components | 0-35 | wt % | 0-35 | wt % |
| TOTAL | 100.00 | wt % | 100.00 | wt % |

While this invention has been described in conjunction with specific embodiments, it is evident that many alternatives, modifications, permutations, and variations will become apparent to those skilled in the art, in light of the foregoing description. Accordingly, it is intended that the present invention embraces all such alternatives, modifications, and variations as fall within the scope of the claims below.

1. A packaged food product comprising:
a heterogeneous mixture at a pH of about 4.6 or less including:
a hydrocolloid mixture comprising chia seeds in a range of about 0.5-3% by weight of the packaged food product and oats in a range of about 2-50% by weight of the packaged food product;
a non-citrus fruit in a range of about 10-60% by weight of the packaged food product; and
sodium bisulfate.

2. The packaged food product of claim 1 wherein the oats are selected from the group consisting of cracked oats, groats, instant rolled oats, steel cut oats, traditional rolled oats, whole grain oats, and unprocessed oats.

3. The packaged food product of claim 1 wherein the non-citrus fruit is selected from the group consisting of apple, apricot, banana, peach, pear, pineapple, and mango.

4. The packaged food product of claim 3 wherein the non-citrus fruit is comminuted, cubed, diced, pulverized, pureed, or sliced.

5. The packaged food product of claim 1 wherein the pH of the packaged food product is about 3-5, about 3.5-4.5, about 3.9, or about 3.6.

6. The packaged food product of claim 1 wherein the sodium bisulfate is in a range of about 0.01-1.5% by weight of the packaged food product.

7. The packaged food product of claim 1 wherein the heterogeneous mixture further comprises fruit juice or vegetable juice.

8. The packaged food product of claim 1 wherein the heterogeneous mixture further comprises any one or combination of color, flavor, juice, non-dairy milk, nuts, salt, spice, seeds other than chia seeds, or sweetener.

9. The packaged food product of claim 1 wherein the heterogeneous mixture further comprises whey protein at about 1% by weight of the packaged food product.

10. The packaged food product of claim 1 wherein the heterogeneous mixture further comprises ascorbic acid.

11. The packaged food product of claim 1 wherein the packaged food product is a ready-to-eat food product.

12-68. (canceled)

69. A process for manufacturing a packaged food product comprising:
soaking oats in a solution of about 0.25-1% sodium bisulfate and a pH of about 1.65 or less, the soaking of oats occurs at an oat-to-water ratio in a range of about 1:2-1:12 to obtain hydrated oats;
draining the solution from the hydrated oats to form drained, hydrated oats;
separately soaking chia seeds in water at a seed-to-water ratio in a range of about 1:2-1:12 to obtain hydrated chia seeds;
mixing the drained, hydrated chia seeds with the hydrated oats to form a heterogeneous mixture having an oat-to-chia seed ratio in a range of about 1:10-1:50 and a pH of about 4.6 or less;
portioning the heterogeneous mixture into containers; and
commercially processing the heterogeneous mixture in the containers.

70. The process of claim 69 wherein the process further comprises rinsing the drained, hydrated oats with fresh water before combining the drained, hydrated oats with the drained, hydrated chia seeds to form the heterogeneous mixture.

71. The process of claim 69 wherein the process further comprises rinsing the drained, hydrated chia seed with fresh water before combining them with the drained, hydrated oats to form the heterogeneous mixture.

72. The process of claim 69 wherein the process further comprises adding non-citrus fruit or vegetable to the heterogeneous mixture.

73. The process of claim 72 wherein the packaged food product comprises vegetable, oats, and chia seeds.

74. The process of claim 72 wherein the packaged food product comprises non-citrus fruit at about 1-60% weight, oats at about 2-40% weight, chia seeds at about 0.1-10% weight, and sodium bisulfate at about 0.01-1.5% weight.

75. The process of claim 74 wherein the packaged food product further comprises whey protein.

76. The process of claim 72 wherein texture, flavor, and color of the non-citrus fruit or the vegetable remain intact relative to their prepackaged form.

77. The process of claim 69 wherein the sodium bisulfate has an effective pKa value of 1.99.

78. The process of claim 69 wherein the oats are acidified by the sodium bisulfate to a pH of between about 3-4.6.

79. The process of claim 69 wherein the water used for the step of soaking the oats is maintained at a temperature in a range of about 120-205 degrees F.

80. The process of claim 69 wherein the oats are soaked for a time period in a range of about 1-20 minutes.

81. The process of claim 69 wherein the water used for the step of soaking the chia seeds is maintained at a temperature in a range of about 120-205 degrees F.

82. The process of claim 81 wherein the chia seeds are soaked for about 20 minutes or less.

83. The process of claim 81 wherein the water used to soak the chia seeds is acidified with sodium bisulfate at a concentration of about 0.25-1%.

84. The process of claim 69 wherein the packaged food product is a ready-to-eat food product.

85. The process of claim 69 the drained, hydrated oats exhibit texture and taste of freshly prepared regular or instant oats.

86. The process of claim 69 wherein the heterogeneous mixture further comprises juice, ascorbic acid, sweetener, salt, flavor, spice, color, seeds other than chai seeds, nuts, or non-dairy milk.

87. A process for manufacturing a packaged food product comprising:
soaking a cereal having about 2-20% weight of β-glucan having about 65-80% water solubility in a solution of about 0.25-1% sodium bisulfate and a pH of about 1.65 or less, the soaking of the cereal occurs at a cereal-to-water ratio in a range of about 1:2-1:12 to obtain hydrated cereal;
draining the solution from the hydrated cereal to form a drained, hydrated cereal;
portioning the drained, hydrated cereal into containers; and
commercially processing the drained, hydrated cereal in the container.

88-120. (canceled)
